(19) United States
(12) Patent Application Publication
(10) Pub. No.: US 2007/0195290 A1
(43) Pub. Date: Aug. 23, 2007

(54) Image projection apparatus

(75) Inventor: Soh Ohzawa, Toyonaka-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.,

(21) Appl. No.: 11/708,732

(22) Filed: Feb. 21, 2007

(30) Foreign Application Priority Data
Feb. 22, 2006 (JP) 2006-044996

(51) Int. Cl. G03B 21/28

(52) U.S. Cl. 353/99

(57) ABSTRACT

A projector is loaded with a projection optical system unit having a refractive optical system, a curved mirror optical system, and a light travel change mirror optical system. Then, the projector has a first curved mirror and a second curved mirror of the curved mirror optical system arranged so that an optical path of a base ray reaching the first curved mirror and an optical path of a base ray leaving the second curved mirror do not intersect with each other, and also has the first curved mirror located between the second curved mirror and a screen surface. Furthermore, an angle of incidence of the base ray on the screen surface is within a predetermined range.

This application is based on Japanese Patent Application No. 2006-044996 filed on Feb. 22, 2006, the contents of which are hereby incorporated by reference.

### BACKGROUND OF THE INVENTION

1. Field of the Invention

The present invention relates to an image projection apparatus which projects on a screen surface image light emitted from a light modulation element, such as an LCOS (Liquid Crystal Silicon) or the like.

2. Description of Related Arts

Various image projection apparatuses (projection TV and the like) have been conventionally developed. There have been demands imposed on such image projection apparatuses for slimmed down so that they do not occupy excessive space in a narrow room and also for image quality as high as (or higher than) image quality provided by a tube television.

From a viewpoint of slimming-down, for example, there are image projection apparatuses disclosed in patent documents 1 and 2 below. The image projection apparatus of patent document 1 has: a turning mirror disposed on the ceiling thereof, a screen disposed on the front surface thereof, and a mirror optical system for guiding image light disposed inside thereof. Image light is guided by the mirror optical system to the turning mirror, and further guided by this turning mirror to the screen surface. Thus, the image light is projected obliquely onto the screen. In this manner, slimming-down of the image projection apparatus of patent document 1 is achieved.

### [Patent Document] JP-A-2002-207190

### [Patent Document] W001/011425

On the other hand, the image projection apparatus of patent document 2 is a slim image projection apparatus which projects image light obliquely on a screen surface by a projection optical system including a mirror optical system having a curved reflection mirror and a lens with substantially non-power.

To improve the image quality of such image projection apparatuses which perform oblique projection, it is possible to use an LCOS composed of a reflective liquid crystal panel having a reflection mirror formed in each pixel. This is because the LCOS can have a drive circuit on the back side of the reflection mirror, thus causing no black matrix (light-intercepting portion), which permits seamless image light generation.

However, for example, with an image projection apparatus using a three-plate type LCOS, image light from three directions is integrated by a prism (integration prism) to thereby generate integrated image light. Thus, chromatic aberration attributable to the integration prism occurs. However, with the image projection apparatuses as in patent documents 1 and 2, image light is mainly guided by the mirror optical system. Thus, these image projection apparatuses fail to perform chromatic aberration correction, thus resulting in failure to satisfy the both demands for slimming-down and higher image quality.

Here, it is possible to use a lens system (refractive optical system) for chromatic aberration correction and to further perform projection of image light with a lens power for slimming-down. However, an attempt to increase the power of the lens for enlarged projection results in occurrence of chromatic aberration. Moreover, performing enlarged projection while suppressing the lens power and further performing color correction results in upsizing of the lens, which in turn results in failure to achieve slimming-down.

### SUMMARY OF THE INVENTION

In view of the problem described above, the present invention has been made, and it is an object of the invention to provide a slim image projection apparatus with high image quality by correcting (suppressing) chromatic aberration and the like while performing enlarged projection.

In an image projection apparatus including a projection optical system unit which performs projection on a projection surface by guiding image light emitted from a light modulation element, the projection optical system unit includes: a refractive optical system having an optical aperture stop; a curved mirror optical system having at least a first curved mirror and a second curved mirror which reflects light reflected via the first curved mirror; and an optical path change mirror optical system which changes a traveling direction of image light at least once.

Provided that image light traveling from a center of a display surface of the light modulation element through a center of the optical aperture stop toward a center of the projection surface is a base ray, an angle θα[°] of incidence of the base ray on the projection surface satisfies conditional formula (1) below:

55<θα<76 Conditional formula (1).

Furthermore, the first curved mirror and the second curved mirror are located so that an optical path of the base ray reaching the first curved mirror and an optical path of the base ray leaving the second curved mirror do not intersect with each other.

The above and other objects and characteristics of the invention will be more clarified by the following description on preferred examples and by referring to the accompanying drawings.

### BRIEF DESCRIPTION OF THE DRAWINGS

FIG. 1 is a schematic optical sectional view of a projector (Example 1) according to the present invention;

FIG. 2 is a schematic optical sectional view mainly showing a projection optical system unit included in the projector of FIG. 1;

FIG. 3 is a schematic perspective view of the projector;

FIG. 4 is a perspective view of global coordinates;

FIG. 5 is a spot diagram in the projector of Example 1;

FIG. 6 is a distortion diagram in the projector of Example 1;

FIG. 7 is an explanatory diagram showing θ1 to θ3 in the projector of Example 1;

FIG. 8 is a schematic optical sectional view of a projector of Example 2;

FIG. 9 is a schematic optical sectional view mainly showing a projection optical system unit included in the projector of FIG. 8;

FIG. 10 is a spot diagram in the projector of Example 2;

FIG. 11 is a distortion diagram in the projector of Example 2;

FIG. 12 is an explanatory diagram showing θ1 to θ3 in the projector of Example 2;

FIG. 13 is a schematic optical sectional view of a projector of Example 3;

FIG. 14 is a schematic optical sectional diagram mainly showing a projection optical system unit included in the projector of FIG. 13;

FIG. 15 is a spot diagram in the projector of Example 3.

FIG. 16 is a distortion diagram in the projector of Example 3;

FIG. 17 is an explanatory diagram showing θ1 to θ3 in the projector of Example 3; and

FIG. 18 is a schematic perspective view of a projector provided with an optical path change element.

### DETAILED DESCRIPTION OF PREFERRED EMBODIMENTS

### First Embodiment

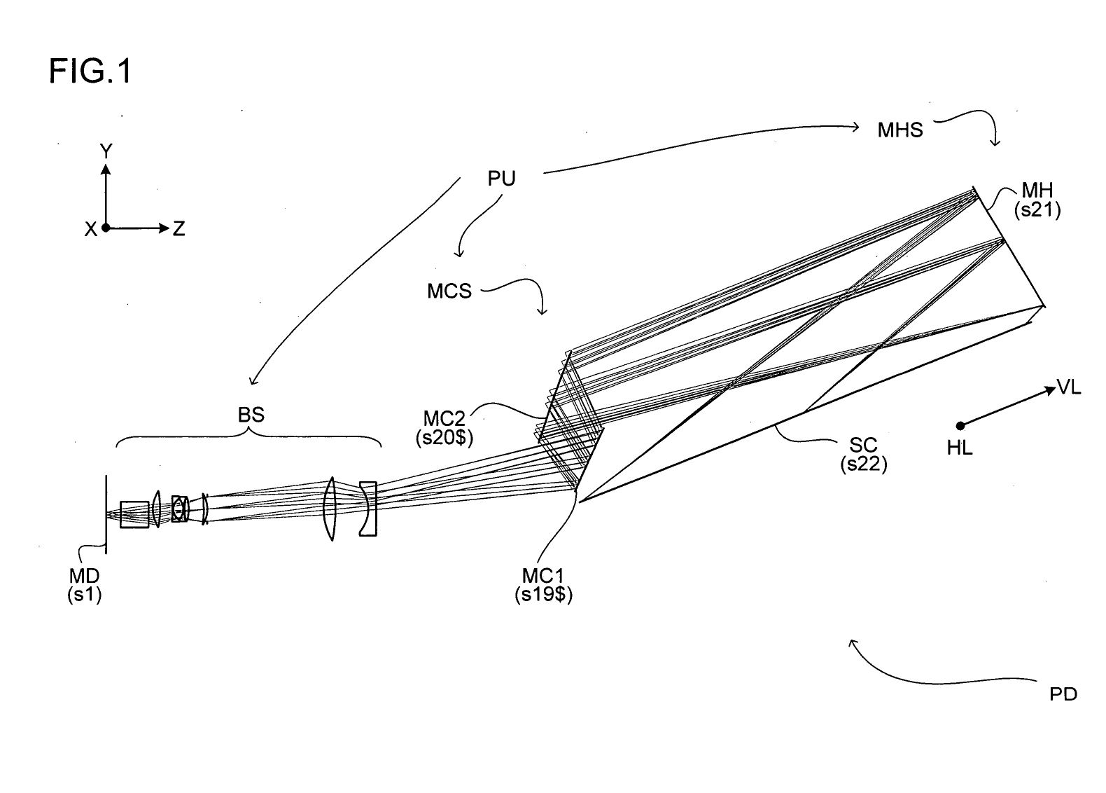

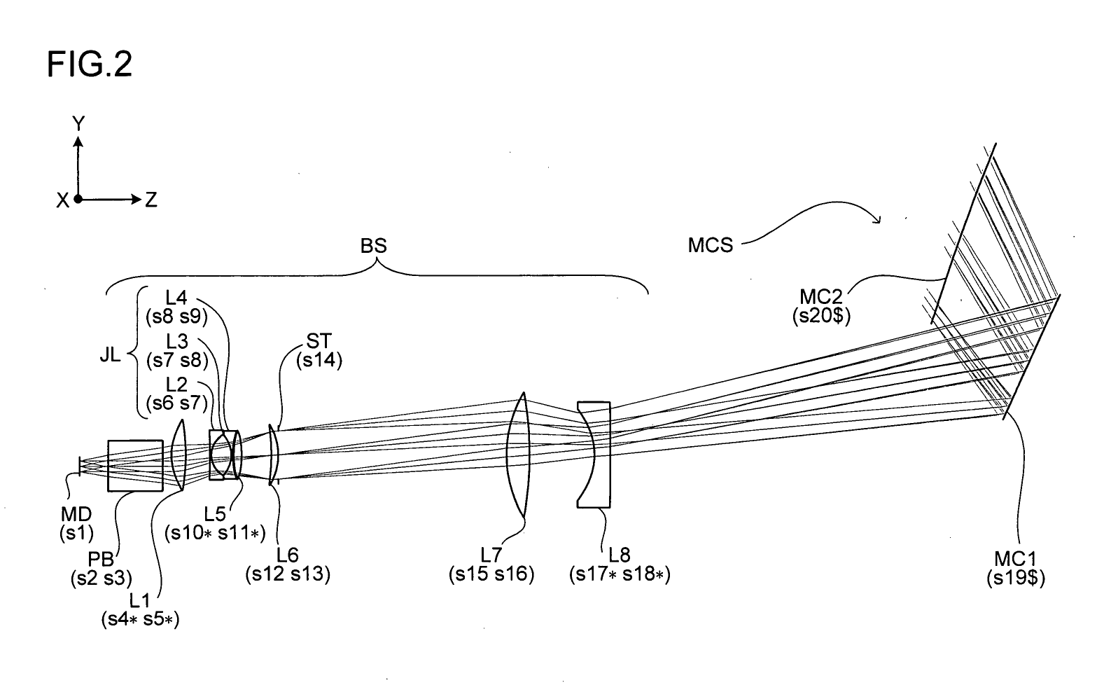

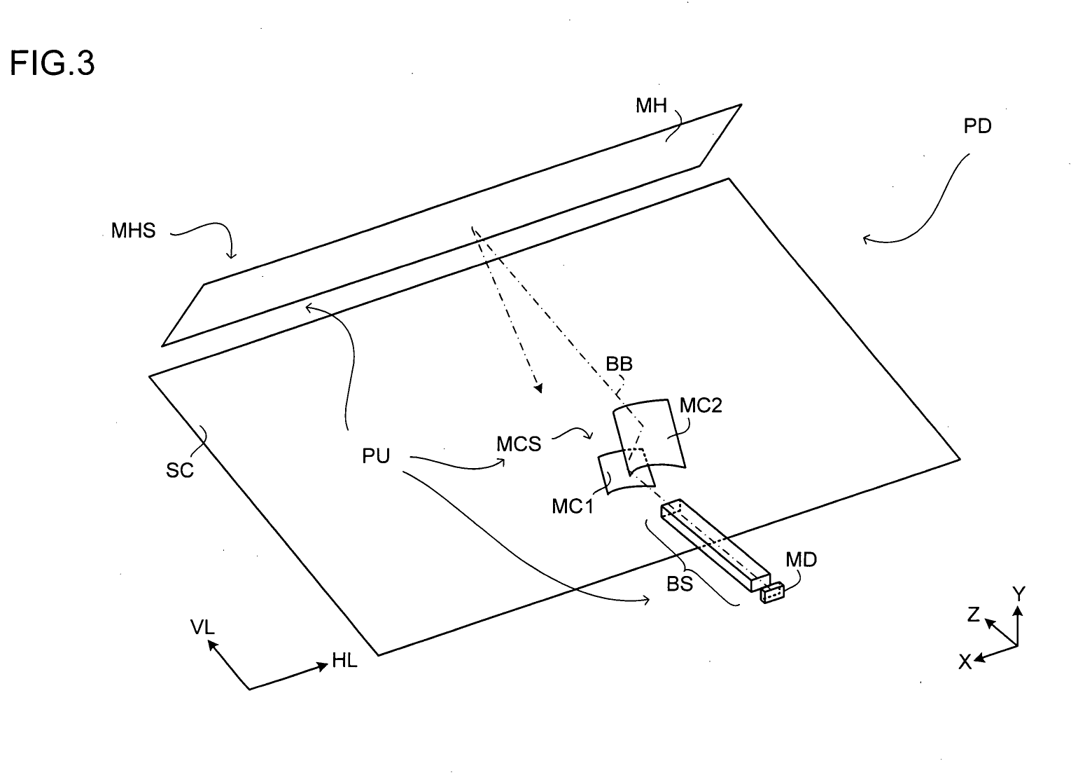

One embodiment of the present invention will be described, referring to the accompanying drawings. FIG. 3 is a schematic perspective view of a projector PD, FIG. 1 is a schematic optical sectional view of the projector PD (YZ cross section of global coordinates to be described later), and FIG. 2 is a schematic optical sectional view mainly showing a projection optical system unit PU (to be described later). The projector PDs shown in FIGS. 1 to 3 are referred to as Example 1.

Optically acting surfaces included in the projector PD are defined as “si” so that those from a light modulation element MD (reduction side) to a screen SC (enlargement side) are numbered in order (where i=1, 2, 3 . . . ) (see FIG. 2). Further, the optically acting surfaces formed into an aspheric shape are each suffixed with a mark “*”, and the optically acting surfaces formed into a free-form shape are each suffixed with a mark “$”. Image light traveling from the center of the light modulation element MD through the center of an optical aperture stop ST toward the center of the screen surface (projection surface) is referred to as a base ray BB (see FIG. 3).

### [1-1. Projector]

Listed as one example of an image projection apparatus is the projectors PD as shown in FIGS. 1 and 3. The projector PD includes a projection optical system unit PU which guides image light emitted from the light modulation element MD to thereby project this image light onto the screen SC (projection surface).

The light modulation element MD receives light (illumination light) from an illumination optical system, not shown, and modulates this light (received beam) based on image data and the like (this modulated light is referred to as image light). Examples of the light modulation element MD include: a DMD (Digital Micromirror Device; manufactured by Texus Instruments (USA)), an LCOS (Liquid Crystal Silicon), and the like. The panel screen surface of this light modulation element MD is referred to as “s1”.

The projection optical system unit PU includes at least: a refractive optical system BS; a curved mirror optical system MCS having a plurality of curved mirrors MC; and a turning mirror optical system MHS (optical path change mirror optical system).

The refractive optical system BS guides to the curved mirror optical system MCS image light traveling from the light modulation element MD. Then, the refractive optical system BS includes: as shown in FIG. 2, a prism block PB; a first lens L1; a joined lens JL (second lens L2, third lens L3, and fourth lens L4); a fifth lens L5; a sixth lens L6; an optical aperture stop ST; a seventh lens L7; and an eighth lens L8.

Details of the optical elements are as follows.
Prism block PB: A prism having at least two surfaces (s2, s3). This prism block PB may play a role as a color integration prism or a PBS (Polarized Beam Splitter).
First lens L1: A positive lens convex on the both sides (reduction side and enlargement side).
Joined lens JL: A lens having the second lens L2, the third lens L3, and the fourth lens L4 joined together with an adhesive agent or the like. The second lens L2 is a negative lens concave on the both sides, the third lens L3 is a positive lens convex on the both sides, and the lens L4 is a negative lens concave on the both sides.
Fifth lens L5: A positive lens convex on the both sides.
Sixth lens L6: A positive meniscus lens concave on the reduction side.
Optical aperture stop ST: An aperture stop which partially intercepts image light and is also expressed as s14.
Seventh lens L7: A positive lens convex on the both sides.
Eighth lens L8: A negative meniscus lens concave on the reduction side.

The curved mirror optical system MCS guides image light traveling from the refractive optical system BS to the turning mirror optical system MHS. The curved mirror optical system MCS of Example 1 includes: a first curved mirror MC1 which reflects image light from the refractive optical system BS; and a second curved mirror MC2 which reflects the image light traveling by being reflected by the first curved mirror MC1.

The turning mirror optical system MHS guides image light traveling from the curved mirror optical system MCS to the screen SC. The turning mirror optical system MHS of Example 1 is composed of one flat mirror MH. Thus, the turning mirror optical system MHS of Example 1 turns back image light leaving the second curved mirror MC2 only once (reflecting the image light by turning it back) to thereby guide the image light to the screen SC (the turning mirror optical system MHS may include a plurality of turning mirrors).

### [1-2. Construction Data for the Projector]

Here, Tables 1 to 13 show construction data for the projector PD of Example 1. Symbols provided in the tables represent as follows.

The symbol “si” represents an optically acting surface where i is a position from the light modulation element MD (s1) to the screen SC (screen surface).

The symbol “ri” represents a radius of curvature (unit; mm) on each optically acting surface where i represents the same position as described above.

The symbol “di” represents a surface interval where i represents the same as described above, but this surface interval (unit; mm) is omitted since the position of the decentered optically acting surface is indicated by the translational and rotational decentering displacements (to be described later).

The symbol “Ni” represents a refractive index (Nd) for a d-line where i represents the same position as described above.

The symbol “vi” represents an Abbe number (vd) for a d-line where i represents the same position as described above.

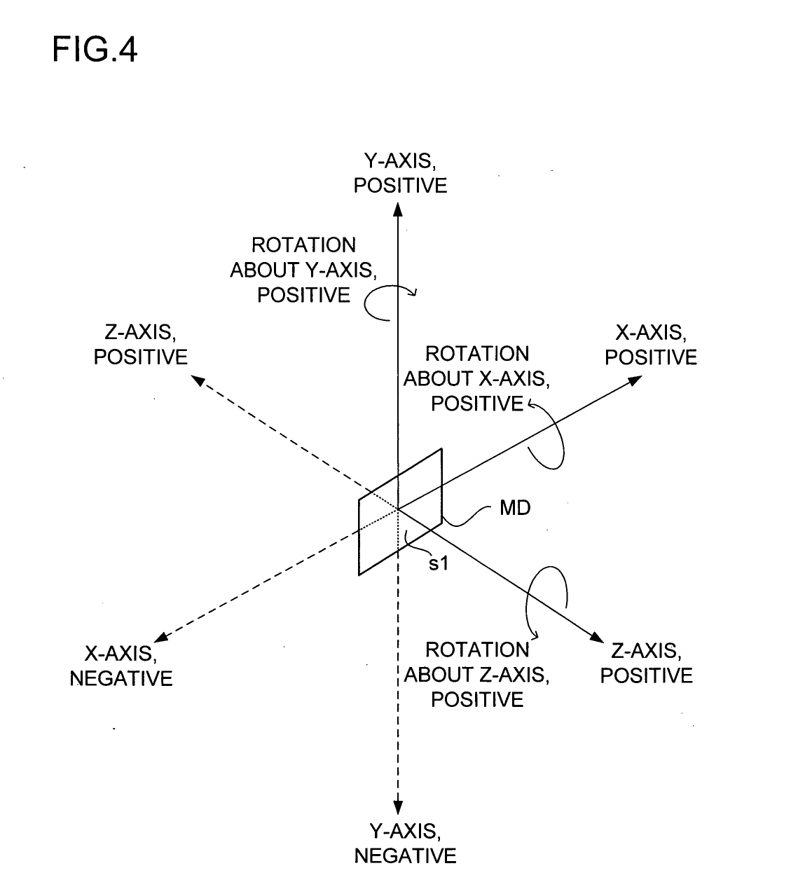

Symbols XDE, YDE, ZDE, ADE, BDE, and CDE represent translational and rotational decentering displacements, based on a global right-handed rectangular coordinate system (X, Y, Z) [=global coordinates] as shown in FIG. 4 with the center position of the panel display surface s1 of the light modulation element MD being provided as an origin and with the normal direction of the panel display surface s1 from the origin being provided as a z-axis direction (where a X-axis corresponds a thumb, a Y-axis corresponds to a forefinger, and a Z-axis corresponds to a middle finger). More specifically, (XDE, YDE, and ZDE) represent surface vertexes of the optically acting surfaces in the global coordinates to thereby repreent translational decentering displacement [unit; mm] in the X-axis direction, translational decentering displacement [unit; mm] in the Y-axis direction, and translational decentering displacement [unit; mm] in the Z-axis direction. Moreover, (ADE, BDE, CDE) represent axial rotation angles, with the surface vertexes provided as centers, to thereby represent X-axis rotational decentering displacement [unit; °], Y-axis rotational decentering displacement [unit; °], and Z-axis rotation decentering displacement [unit; °]. Note that, for ADE and BDE, a counterclockwise direction with respect to the X-axis positive direction and the Y-axis positive direction is defined as “positive”, and for CDE, a clockwise direction with respect to the Z-axis positive direction is defined as “positive”.

The symbols K, A, B, C, and D represent aspheric surface data where an aspheric surface is represented by definitional expression (AS) below using right-handed rectangular coordinates (x, y, z) [=local coordinates] with the surface vertex of the optically acting surface being provided as an origin and with the normal direction of the optically acting surface from the origin being provided as a z-axis direction.

$$z = c \cdot {h}^{2} / \{ 1 + \sqrt{1 - ( 1 + k ) \cdot {c}^{2} \cdot {h}^{2}} \} + A \cdot {h}^{4} + B \cdot {h}^{6} x + C \cdot {h}^{8} + D \cdot {h}^{10} + E \cdot {h}^{12} + F \cdot {h}^{14} + G \cdot {h}^{16} + H \cdot {h}^{18} + J \cdot {h}^{20} , \qquad Definitional equation ( AS )$$

where
z: represents an amount of displacement in the z-axis direction at position (x, y) (with reference to the surface vertex);
h: represents a height in a direction perpendicular to the z-axis (h2=x2+y2);
c: represents paraxial curvature (1/radius of curvature);
k: represents a conic constant; and

A, B, C, D, E, F, G, H, I, and J: represents aspheric surface coefficients. As aspheric surface data, values of the aspheric surface coefficients (A, B, C, and D) which are other than k and “0 (zero)” are indicated where “E−n” is “10⁻ⁿ”.

The symbol C (m, n) represents free-form surface data where the free-form surface is represented by definitinal expression (FS) below using local right-handed rectangular coordinates (x, y, z) with the surface vertex of the optically acting surface being provided as an origin and with the normal direction of the optically acting surface from the origin being provided as a z-axis direction:

$$z = c \cdot {h}^{2} / \{ 1 + \sqrt{1 - ( 1 + k ) \cdot {c}^{2} \cdot {h}^{2}} \} + {\sum }_{j = 2}^{66} {C}_{j} \cdot {x}^{m} \cdot {y}^{n} , \qquad Definitional equation ( FS )$$

where
z: represents an amount of displacement in the z-axis direction at position (x, y) (with reference to the surface vertex);
h: represents a height in a direction perpendicular to the x-axis (h²=x²+y²);
c: represents paraxial curvature (1/radius of curvature);
k: represents a conic constant (note that k=0 for a free-form surface); and
Cj: represents a free-form surface coefficient (where =[(m+n)²+m+3n]/2+1).

As the free-form surface data, a value of the free-form surface coefficient [Cj[=C(m,n)]] is incidcated where “E−n” is “10⁻ⁿ”.

### [1-3. Spot Diagram and Distortion Diagram]

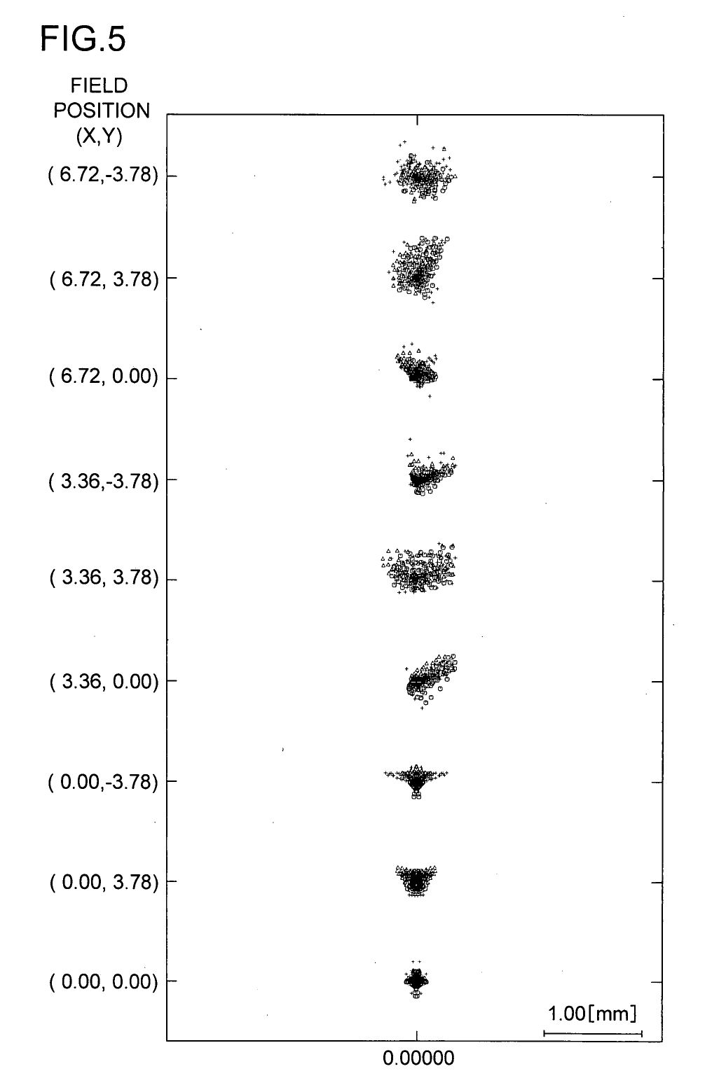

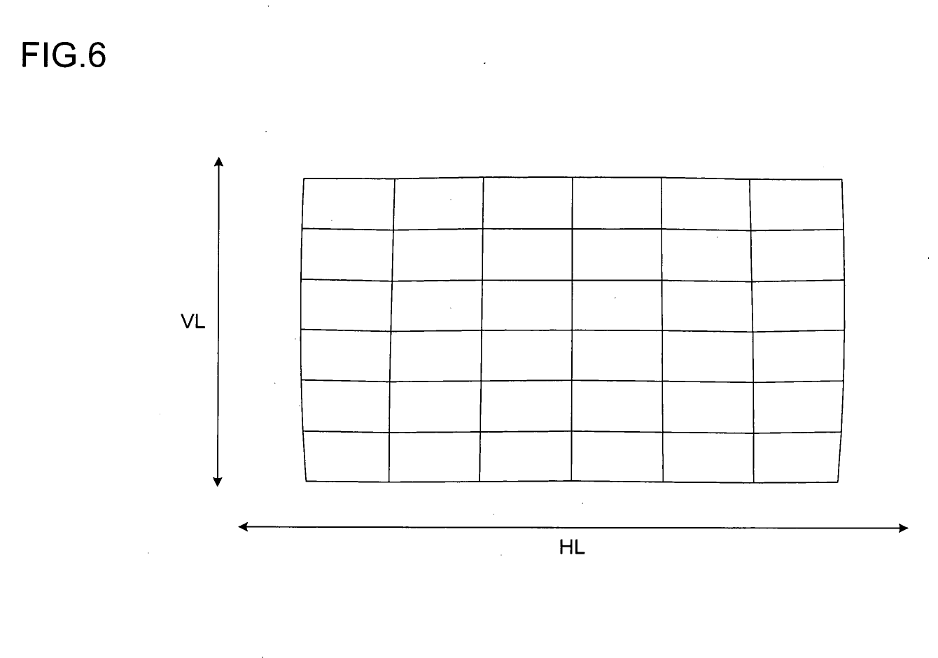

Next, optical performance of the projector PD of Example 1 is indicated in the spot diagram and the distortion diagram (see FIGS. 5 and 6). The spot diagram of FIG. 5 shows focusing characteristics [unit; mm] provided by a d-line, a g-line, and a c-line on the screen surface. (Note that the FIELD POSITION (X, Y) indicates a beam passage position on the panel display surface.

On the other hand, the distortion aberration diagram of FIG. 6 shows distortion of a light image on the screen surface. On the screen surface, a rectangular coordinate system (HL, VL) is specified with one direction being referred to as a horizontal direction (HL) and with the other direction being referred to as a vertical direction (VL) {the axis of the horizontal direction (HL) and the x-axis of the local coordinates on the screen surface are the same, and the axis of the vertical direction (VL) and the y-axis of the local coordinates on the screen surface are the same}.

The object side F No. is “2.53” in the projector PD of Example 1. The scale of enlargement {image magnification β(x)} of the local coordinate (x-axis direction) on the screen surface is “−85.8”, and the scale of enlargement {image magnification β(y)} of the local coordinate (y-axis direction) on the screen surface is “−85.8” {the values of image magnification are provided with negative signs (minus) because the directions of the x-axis and the y-axis of the local coordinates are opposite between the panel display surface and the screen surface}.

### [1-4. One Example of Characteristics]

As described above, the projector PD is provided with the projection optical system unit which guides image light emitted from the light modulation element MD to thereby project the image light on the screen surface. Then, this projection optical system unit PU has the refractive optical system BS, the curved mirror optical system MC, and the turning mirror system MHS.

The refractive optical system BS is located between the light modulation element MD and the screen SC so as to transmit image light traveling from the light modulation element MD toward the screen SC. Thus, the refractive optical system BS is capable of correcting (suppressing) various aberration when transmitting image light.

For example, if the light modulation element MD is a three-plate type LCOS, a color integration prism is used for the purpose of integrating image light of three colors, but chromatic aberration attributable to this usage occurs. However, like the projector PD, having the refractive optical system BS in the projection optical system unit PU provides ability to correct chromatic aberration by this refractive optical system BS. Effect of such chromatic aberration correction in particular is more likely to appear remarkably than effect of correction achieved by use of a mirror only.

The projection optical system unit PU also includes the curved mirror optical system MCS. This curved mirror optical system MCS has a plurality of curved mirrors MC (more specifically, the first curved mirror MC1 and the second curved mirror MC2). Including a plurality of curved mirrors MC in the curved mirror optical system MCS as described above permits image light to travel while being reflected by the plurality of curved mirrors MC. Thus, the curvature of field and distortion can be corrected efficiently by using a reflection surface of a curved shape.

Including a plurality of curved mirrors MC in particular permits more effective aberration correction in accordance with an excess number of mirrors than aberration correction (correction of curvature of field and distortion) performed by use of a single curved mirror. Moreover, aberration correction using a single curved mirror, which is performed on one reflection surface, results in a reflection surface of a relatively wide size. However, aberration correction using a plurality of curved mirrors MC permits load of aberration correction to be divided to the curved mirrors MC, thus permitting the size of a reflection surface of each curved mirror to be narrowed down.

Furthermore, in addition to the curved mirror optical system MCS including the curved mirrors MC which have been narrowed down (downsized), the projection optical system unit PU includes the turning mirror optical system MHS. Thus, the optical path from the light modulation element MD to the screen SC (screen surface) is turned back a plurality of times by the curved mirror optical system MCS and the turning mirror optical system MHS. Therefore, the projection optical system unit PU, unlike a straight optical system, is not so structured as to extend in one direction. Thus, it can be said that such a projection optical system unit PU is designed to be compact and thus can be easily loaded in the projector PD.

As one example of the projection optical system unit PU designed to be compact, the first curved mirror MC1 and the second curved mirror MC2 are arranged (located) so that an optical path of the base ray BB reaching the first curved mirror MC 1 and an optical path of the base ray BB leaving the second curved mirror MC2 do not intersect with each other.

With such arrangement, for example, as shown in FIG. 1, the optical path reaching the first curved mirror MC1 from the refractive optical system BS and the optical path from the second curved mirror MC2 up to the turning flat mirror MH extend in one direction substantially parallel to each other but the optical path reaching the second curved mirror MC2 from the first curved mirror MC1 extends in a direction not the same as the aforementioned one direction. Thus, the length of the one direction is reduced by the length of the optical path reaching the second curved mirror MC2 from the first curved mirror MC1.

Arrangement of the screen surface such that it extends in the same direction as the aforementioned one direction (that is, arrangement such that the thickness direction of the screen surface and the one direction become substantially perpendicular to each other), the length of the projection optical system unit PU along the one direction has no influence on the thickness of the projector PD.

There is conditional formula, shown in conditional formula (1) below, suitable for, in addition to providing no influence on the thickness of the projector PD, improving in the image quality of the projector PD.

55<θα<76 Conditional formula (1)

where
θα represents the angle [°] of incidence of the base ray BB with respect to the screen surface.

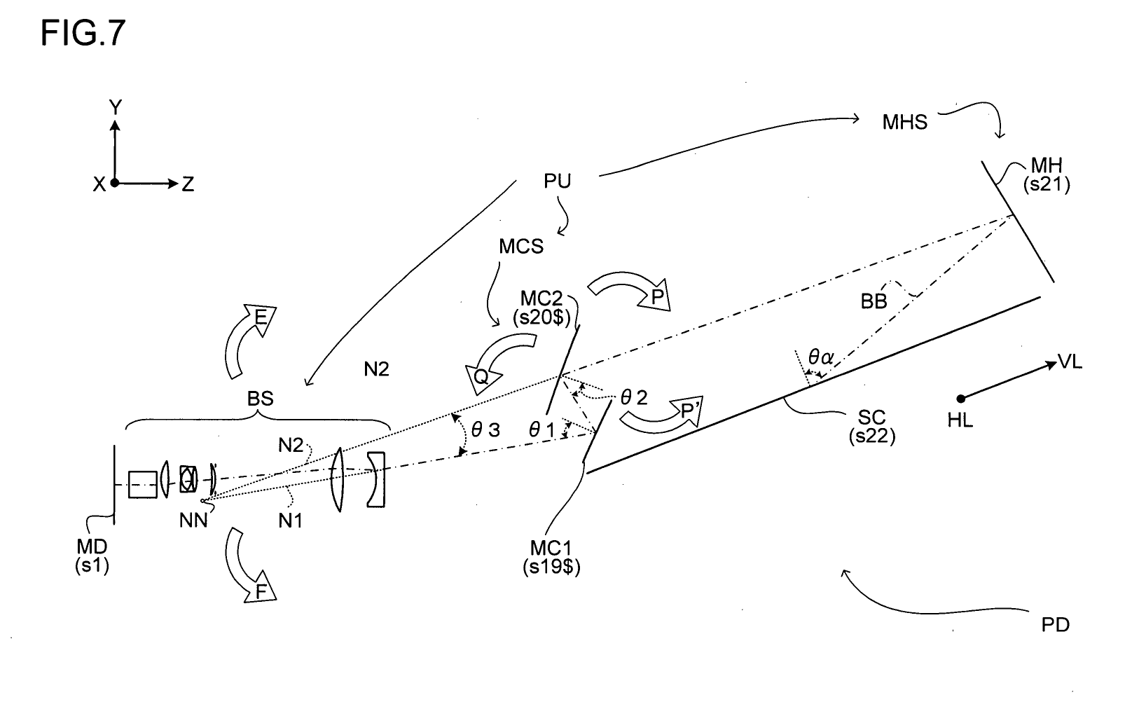

For example, separation of the refractive optical system BS from the screen SC may result in a value of θα equal to or smaller than the lower limit (see FIG. 7). In such a case, due to the separation of the screen SC and the refractive optical system BS from each other, the thickness of the projector PD is less likely to become thin.

On the other hand, too close approach between the refractive optical system BS and the screen SC may result in a value of θα equal to or larger than the upper limit. In such a case, so-called oblique projection becomes too strict, thus resulting in difficulty in correcting trapezoid distortion attributable to this oblique projection (causing image quality deterioration).

Therefore, setting the value of θα within the range of the conditional formula (1) prevents upsizing of the projector PD and also prevents image quality deterioration. Moreover, with the value of θα within the range of the conditional formula (1), the screen surface and the base ray BB leaving the second curved mirror MC2 become substantially parallel to each other. Thus, the length of the screen surface in the vertical direction (VL) has no influence on the depth of the projector PD.

For the projector PD of Example 1, the value of θα is “70.57”, which falls within the range of the conditional formula (1).

Moreover, locating the first curved mirror MC1 between the second curved mirror MC2 and the screen surface locates the first curved mirror MC1 behind the screen surface. Thus, the refractive optical system BS which emits image light toward the first curved mirror MC1, and the like approach the screen side, the screen rear surface in particular, in such a manner as to enter thereinto. Thus, the portion projecting from the screen-rear surface (chin portion; distance from the screen end to the housing end of the projector PD) becomes relatively short. Therefore, such a projector PD can be said to be compact while having a large screen.

Appropriately setting various angles (θ1 to θ3) shown in FIG. 7 permits achieving further slimming-down (downsizing) and higher performance (control of various aberration) of the projector PD. For example, it is preferable that the projector PD satisfy conditional formula (2) below.

25<θ1<45 Conditional formula (2),

where
θ1: represents the angle [unit; °] of incidence of the first curved mirror MC1 with respect to the base ray BB.

For example, displacement of the refractive optical system BS in a direction of an arrow E (location change thereof due to fluctuation by rotational movement, sliding movement, rotational sliding, or the like) may result in a value of θ1 equal to or smaller than the lower limit. In such a case, there arises a problem that part of image light emitted from the refractive optical system BS is intercepted (insterfered) by the second curved mirror MC2.

On the other hand, displacement of the refractive optical system BS in a direction of an arrow F may result in a value of θ1 equal to or larger than the upper limit. In such a case, the refractive optical system BS approaches the screen SC too closely, thus causing a problem of enlargement of the chin portion (jaw).

Therefore, setting the θ1 falls within the range of the conditional formula (2) permits, in the projector PD, preventing such a situation that part of image light does not reach the screen surface and also permits avoiding the enlargement of the chin portion.

It is preferable that, of the range of the conditional formula (2), a range of conditional formula (2a) below be satisfied:

30<θ1<40 Conditional formula (2a).

For example, if the value of θ1 in the conditional formula (2a) is equal to or smaller than the lower limit, situation that part of light emitted from the refractive optical system BS is intercepted by the second curved mirror MC2 can be avoided, but the refractive optical system BS moves in the direction of the arrow E, thus resulting in a large thickness of the projector PD.

On the other hand, if the value of θ1 in the conditional formula (2a) is equal to or larger than the upper limit, excessive enlargement of the chin portion attributable to close approach of the refractive optical system BS to the screen SC does not occur, but distortion of a trapezoid shape occurs since the angle of incidence of image light with respect to the first curved mirror MC1 is relatively large.

Therefore, setting the value of θ1 within the range of the conditional formula (2a) permits suppressing the occurrence of distortion while decreasing the thickness (depth) of the projector PD.

For the projector PD of Example 1, the value of θ1 is “34.1”, which falls within the ranges of the conditional formulas (2) and (2a).

Moreover, it is preferable that the projector PD satisfy conditional formula (3) below.

30<θ2<50 Conditional formula (3),

where
θ2 represents the angle [unit; °] of incidence of the base ray BB with respect to the second curved mirror MC2.

For example, displacement of the second curved mirror MC2 in a direction of an arrow P may result in a value of θ2 equal to or smaller than the lower limit. In such a case, there arises a problem that part of image light emitted from the second curved mirror MC2 is intercepted by the first curved mirror MC1.

On the other hand, displacement of the refractive optical system BS in a direction of an arrow Q may result in a value of θ2 equal to or larger than the upper limit. In such a case, there arises a problem that part of the image light emitted from the refractive optical system BS is intercepted by the second curved mirror MC2. Moreover, moving the refractive optical system BS to the screen side (F direction) to avoid such a problem results in too close approach between the two (the refractive optical system BS and the screen SC), causing a problem of enlargement of the chin portion.

Therefore, setting the value of θ2 within the range of the conditional formula (3) permits preventing, in the projector PD, situation that part of image light does not reach the screen surface and also permits avoiding the enlargement of the chin portion.

It is preferable that, of the range of the conditional formula (3), conditional formula (3a) below be satisfied.

35<θ2<45 Conditional formula (3a).

For example, displacement of the first curved mirror MC1 in a direction of an arrow P′ may result in a value of θ2 in the conditional formula (3a) equal to or smaller than the lower limit. In such a case, there arises a problem that part of image light traveling toward the screen surface is intercepted by the first curved mirror MC1. Moreover, following the displacement of the first curved mirror MC1 in the direction of the arrow P′, the refractive optical system BS also approaches the screen SC, causing a problem of enlargement of the chin portion.

On the other hand, if the value of θ2 in the conditional formula (3a) is equal to or larger than the upper limit, there arises no problem that part of image light emitted from the refractive optical system BS is intercepted by the second curved mirror MC2, but the angle of incidence of the image light on the second curved mirror MC2 is relatively large, thus causing distortion of a trapezoidal shape.

Therefore, setting the value of θ2 within the range of the conditional formula (3a) permits, in the projector PD, suppressing occurrence of distortion while avoiding the situation that part of image light does not reach the screen surface and also avoiding the enlargement of the chin portion

For the projector PD of Example 1, the value of θ2 is “39.0”, which falls within the ranges of the conditional formulas (3) and (3a).

Moreover, it is preferable that the projector PD satisfy conditional formula (4) below:

0<θ3<20 Conditional formula (4),

where
θ3: represents the angle [unit; °] formed by a direction of the base ray BB reaching the first curved mirror MC1 and a direction of the base ray BB leaving the second curved mirror MC2.

Further, it is more preferable that, of the range of the conditional formula (4), a range of conditional formula (4a) below be satisfied:

5<θ3<15 Conditional formula (4a).

The direction of the base ray BB entering the first curved mirror MC1 is, in another word, a direction of a virtual line N1 extending in a direction opposite to the travel direction of the optical path reaching the first curved mirror MC1. Moreover, the direction of the base ray BB emitted from the second curved mirror MC2 is, in another word, a direction of a virtual line N2 extending in a direction opposite to the traveling direction of the optical path leaving the second curved mirror MC2. Thus, θ3 is an angle formed by the virtual lines N1 and N2. Furthermore, assuming that an interception between the virtual lines N1 and N2 is an interception NN, the θ3 is an angle (acute angle) formed by the virtual line N1 extending from the interception NN toward the first curved mirror MC1 and the virtual line N2 extending from the interception NN toward the second curved mirror.

Then, these conditional formulas (4) and (4a) define the thickness of the projector PD. For example, displacement of the refractive optical system BS in the E direction may result in a value of θ3 equal to or larger than the upper limit. In such a case, the refractive optical system BS is separated from the first curved mirror MC1 located behind the screen SC, thus resulting in an increase in the interval between the screen SC and the refractive optical system BS, which in turn results in an increase in the thickness of the projector PD. Therefore, setting the value of the θ3 within the range of the conditional formula (4) or (4a) permits the projector PD to be kept slim.

For the projector PD of Example 1, the value of the θ3 is “9.80°”, which falls within the ranges of the conditional formulas (4) and (4a).

The projector PD also achieves enlarged projection of image light by using the power (refractive power) of the curved mirror MC. Thus, appropriately setting the power of the curved mirror MC also permits achieving higher performance {improvement in the power of correcting (power of suppressing) various aberration} and slimming-down (downsizing). Thus, it is preferable that the projector PD satisfy conditional formula as shown below.

For example, it is preferable that the projector PD satisfy conditional formula (5) below:

−3.3<H×r(MC1)<−1.0 Conditional formula (5),

where
H: represents the length [unit; mm] of one direction {horizontal direction (HL)} of a rectangular coordinate system defined on the screen surface; and
r(MC1): represents the curvature [unit; 1/mm], at the point of the reflection surface of the first curved mirror MC1 where the base ray BB reaches, in the same direction as a horizontal direction (HL) possessed by this reflection surface (that is, x-axis direction of the local coordinates) (if the reflection surface is concave, the sign of the curvature value is “negative”).

Further, it is more preferable that, of the range of the conditional formula (5), a range of conditional formula (5a) below be satisfied:

−2.8<H×r(MC1)<−1.8 Conditional formula (5a).

For example, the absolute value of r(MC1) may become large and the value of H×r(MC1) may become equal to or smaller than the lower limit. In such a case, the power (converging power) in the x-axis direction in the first curved mirror MC1 is relatively strong, thereby causing curvature of field, distortion, and the like. Thus, it is hard to say that such a projector provides higher performance (higher definition).

On the other hand, the absolute value of r(MC1) may become small and the value of H×r(MC1) may become equal to or larger than the upper limit. In such a case, the power in the x-axis direction in the first curved mirror MC1 is relatively weak, and the width of a luminous flux of image light guided from the first curved mirror MC1 to the second curved mirror MC2 widens (the width of the luminous flux in the x-z cross section widens). Thus, the size of the reflection surface of the second curved mirror MC2 inevitably needs to be increased in order to receive the widening image light (increase in the size of the reflection surface leads to cost increase of the second curved mirror MC2 and eventually the projector PD).

Moreover, to receive the widening image light without increasing the size of the reflection surface of the second curved mirror MC2, the second curved mirror MC2 needs to be arranged at a position relatively separated from the first curved mirror MC1. Thus, such s projector is not slimmed-down.

Therefore, setting the value of H×r(MC1) within the range of the conditional formula (5) permits, in the projector PD, suppressing the curvature of field, distortion, and the like and also permits narrowing down the size of the reflection surface of the second curved mirror MC2 or reducing the interval between the first curved mirror MC1 and the second curved mirror MC2. That is, within such a range, a low-price, high performance, slim projector PD can be achieved.

For the projector PD of Example 1, the length (H) in the horizontal direction (HL) of the screen surface is “1155 (mm)”, and the curvature of the reflection surface s19$ of the first curved mirror MC1 is as shown below:
curvature {r(MC1)} of the reflection surface s19$ in the x direction=−0.00203(1/mm); and
curvature of the reflection surface s19$ in the y direction=0.00051(1/mm)

### As a result, the value of H×r(MC1) is “−2.33928”, which falls within the ranges of the conditional formulas (5) and (5a).

It is preferable that the projector PD satisfy conditional formula (6) below:

6.0<H×r(MC2)<11.0 Conditional formula (6),

where
H: represents the length [unit; mm] in one direction {horizontal direction (HL)} of a rectangular coordinate system defined on the screen surface; and
r(MC2): represents the curvature [unit; 1/mm], at the point of the reflection surface of the second curved mirror MC2 where the base ray BB reaches, in the same direction as a horizontal direction (HL) possessed by this reflection surface (that is, x-axis direction of the local coordinates) (if the reflection surface is convex, the sign of the curvature value is “positive”).

For example, the value of r(MC2) may become small, and thus the value of H×r(MC2) become equal to or smaller than the lower limit. In such a case, the negative power (diverging power) in the x-axis direction in the second curved mirror MC2 is relatively weak. Thus, image light is not enlarged (angle is not widened) satisfactorily along the horizontal direction (HL) of the screen surface, the same direction as the x-axis direction.

To prevent such situation, the interval between the second curved mirror MC2 and the screen SC needs to be increased, that is, the optical path from the second curved mirror MC2 up to the screen SC needs to be extended. However, such an attempt to extend the optical path results in a larger thickness of the projector PD. Thus, such a projector is not slimmed-down.

On the other hand, the value of r(MC2) may become large and thus the value of H×r(MC2) may become equal to or larger than the upper limit. In such a case, the positive power in the x-axis direction in the second curved mirror MC2 is relatively strong, thereby causing curvature of field, distortion, and the like. Thus, such a projector does not provide higher performance (higher definition).

Therefore, setting the value of H×r(MC2) within the range of the conditional formula (6) permits, in the projector PD, reducing the interval between the second curved mirror MC2 and the screen and also permits suppressing curvature of field, distortion, and the like. That is, within such a range, a slim, high-performance projector PD is achieved.

Moreover, it is more preferable that, of the range of the conditional formula (6), conditional formula (6a) below be satisfied:

7.0<H×r(MC2)<10.0 Conditional formula (6a).

For example, if the value of H×r(MC2) in the conditional formula (6a) is equal to or smaller than the lower limit, an increase in the interval between the second curved mirror MC2 and the screen SC can be prevented, but the negative power in the x-axis direction in the second curved mirror MC2 is relatively weak. In such a case, increasing the size of the reflection surface of the second curved mirror MC2 permits enlarged projection of image light. However, increasing the size of the reflection surface the second curved mirror MC2 may lead to an increase in the thickness of the projector PD (moreover, the increase in the size of the reflection surface leads to cost increase of the second curved mirror MC2 and eventually the projector PD).

On the other hand, if the value of H×r(MC2) in the conditional formula (6a) is equal to or larger than the upper limit, the power of the second curved mirror MC2 is still relatively strong; thus, it is hard to say that curvature of field, distortion, and the like are suppressed.

Therefore, setting the value of H×r(MC2) within the range of the conditional formula (6a) permits, in the projector PD, satisfactorily suppressing curvature of field, distortion, and the like while using a relatively small-size second curved mirror MC2. That is, within such a range, a low-price, slim, high-performance projector PD is achieved.

For the projector PD of Example 1, the length (H) of the screen surface in the horizontal direction (HL) is, as the same as above, “1155 (mm)”, and the curvature of the reflection surface s20$ of the second curved mirror MC2 is as shown below:
Curvature {r(MC2)} of the reflection surface s20$ in the x-direction=0.00687(1/mm); and
Curvature of the reflection surface s20$ in the y-direction=−0.00050(1/mm).

### As a result, the value of H×r(MC2) is “7.94061”, which falls within the ranges of the conditional formulas (6) and (6a).

Based on the above, it is preferable that the shape of the second curved mirror MC2 in the x-axis direction at a point where the base ray BB reaches (shape in the x-z cross section) be convex. This is because, if the horizontal direction (HL) on the screen surface and the x-axis direction of the second curved mirror MC2 are the same, enlarged projection of image light is performed due to this convex shape.

On the other hand, it is preferable that the shape of the second curved mirror MC2 in the y-axis direction at a point where the base ray BB reaches (shape in the y-z cross section) be concave. This is because widening of image light in the y-z cross section has influence on the thickness of the projector PD. That is, the concave shape of the reflection surface of the second curved mirror MC2 permits the width of a luminous flux to be narrowed down by converging image light, thereby reducing the thickness of the projector PD.

### 2. Second Embodiment

The second embodiment will be described. Members having the same function as those used in the first embodiment are provided with the same symbols and thus omitted from the description.

The projector PD of Example 1 has the projection optical system unit PU including the refractive optical system BS, the curved mirror optical system MCS, and the turning mirror optical system MHS (as is the case with Example 1, one turning flat mirror MH), although not limited thereto.

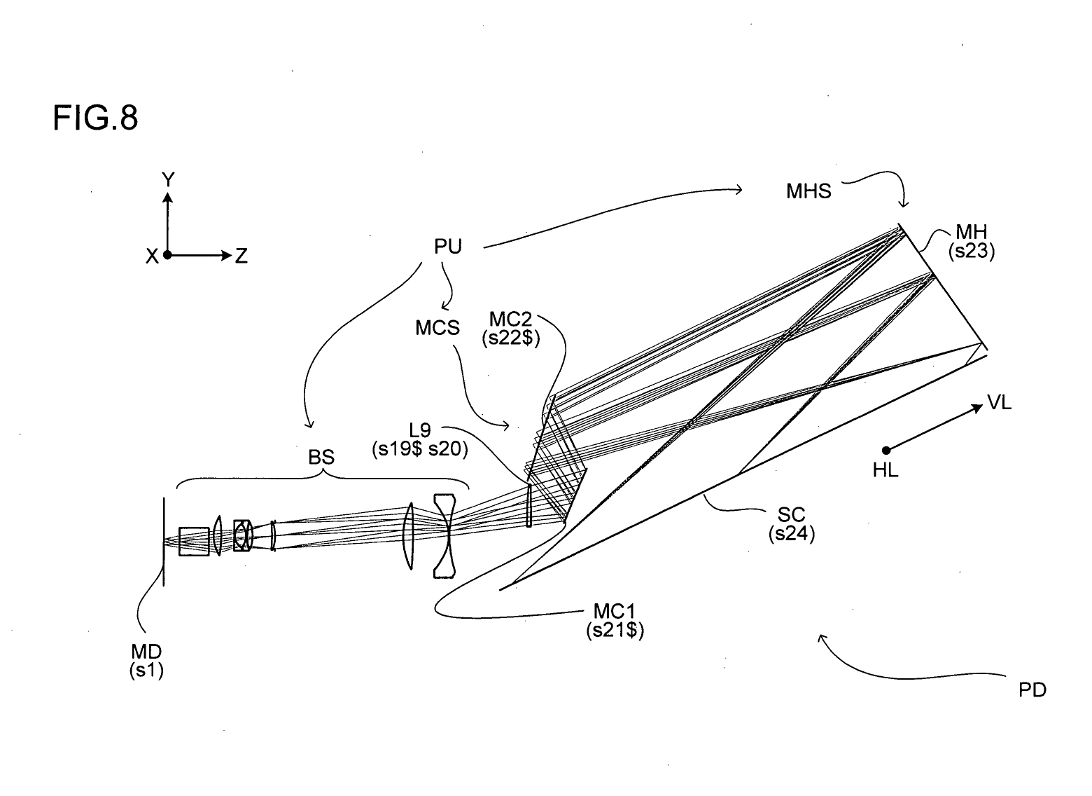

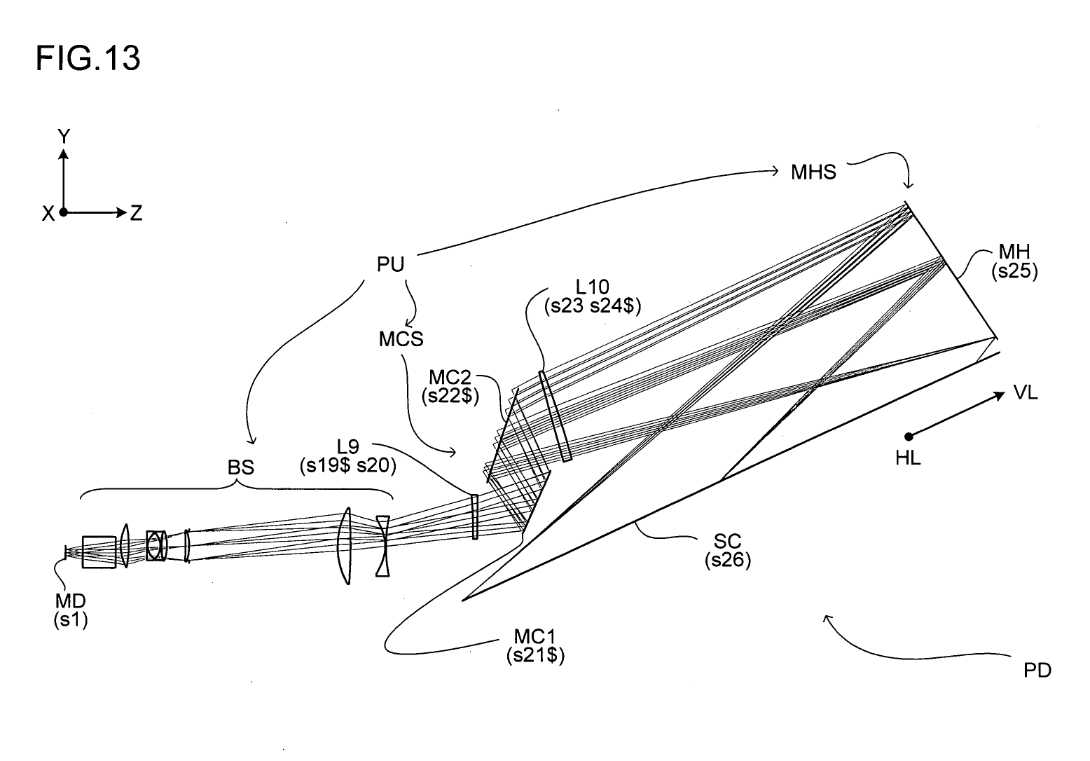

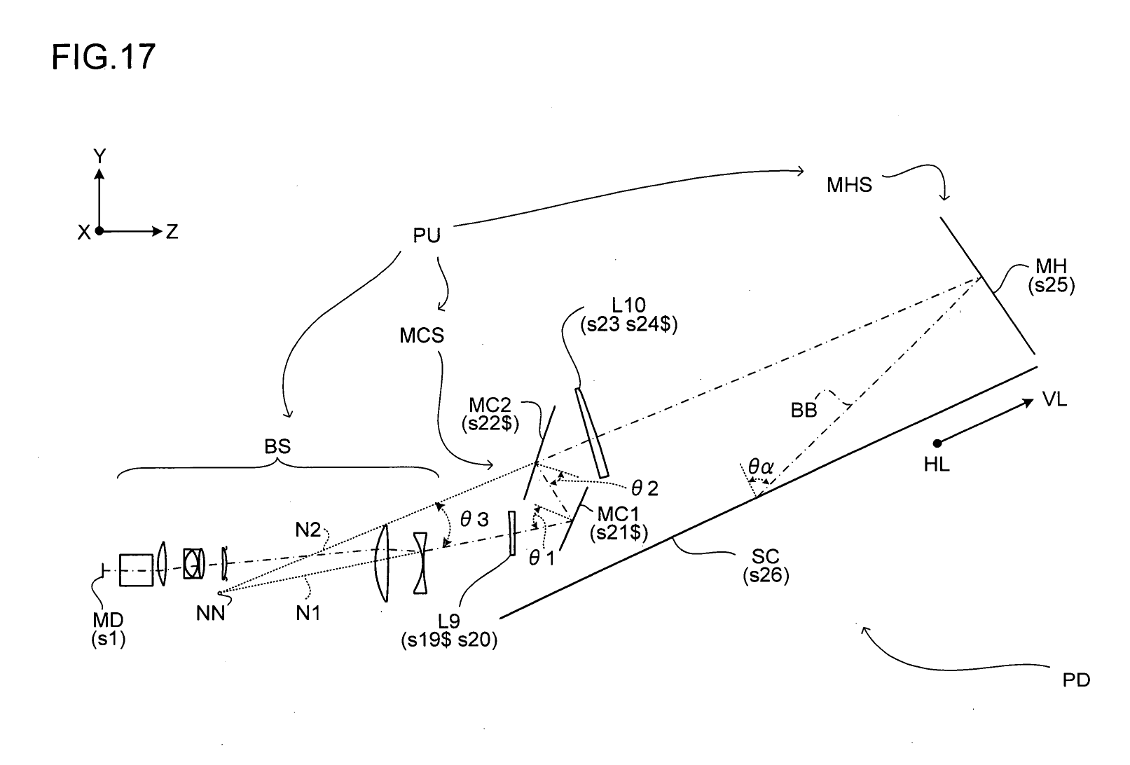

For example, the projection optical system unit PU may include a lens (for example, aberration correcting lens) different from the refractive optical system BS. Thus, examples (Examples 2 and 3) different from Example 1 will be described, referring to FIGS. 8 to 17. FIGS. 8 to 12 relate to Example 2 and FIGS. 13 to 17 relate to Example 3.

### [2-1. Projector PD of Example 2]

As shown in FIG. 8, a projection optical system unit PU in the projector PD of Example 2 includes a refractive optical system BS, a curved mirror optical system MCS, a turning mirror optical system MHS, and also one aberration correcting lens (ninth lens L9). On the other hand, as shown in FIG. 13, a projection optical system unit PU in the projector PD of Example 3 includes a refractive optical system BS, a curved mirror optical system MCS, a turning mirror optical system MHS, and two aberration correcting lenses (ninth lens L9 and tenth lens L10). Thus, the refractive optical system BS and the aberration correcting lens will be described below.

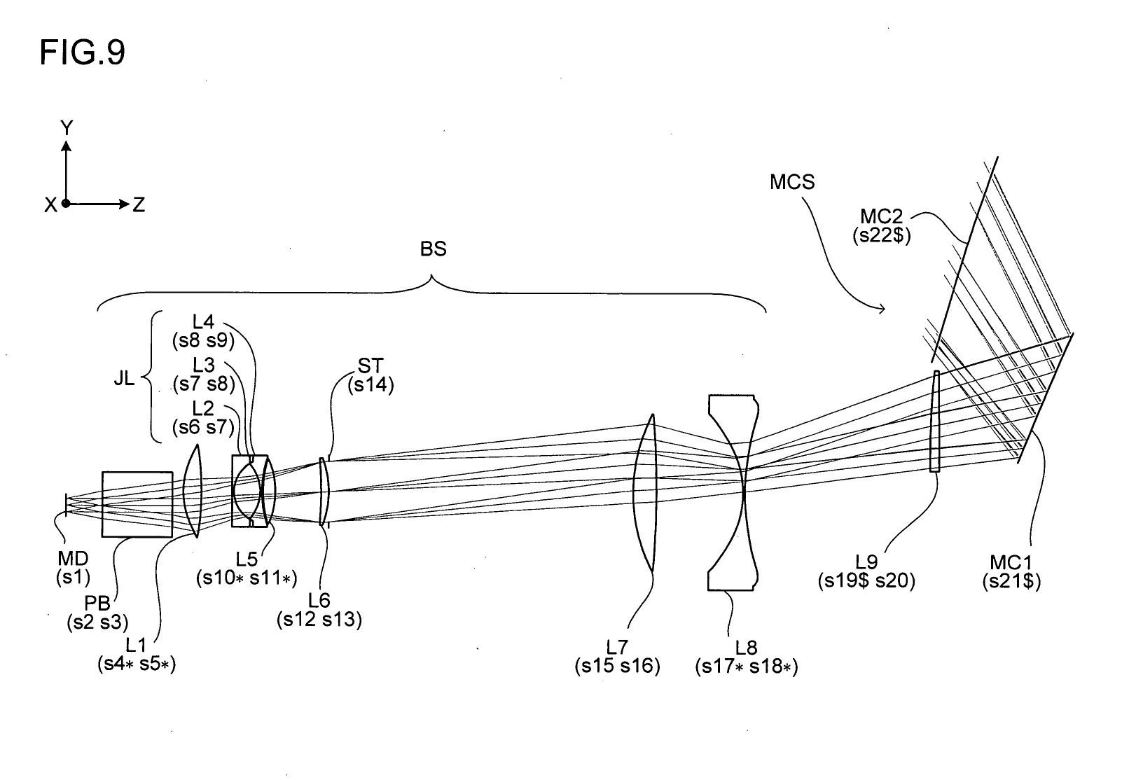

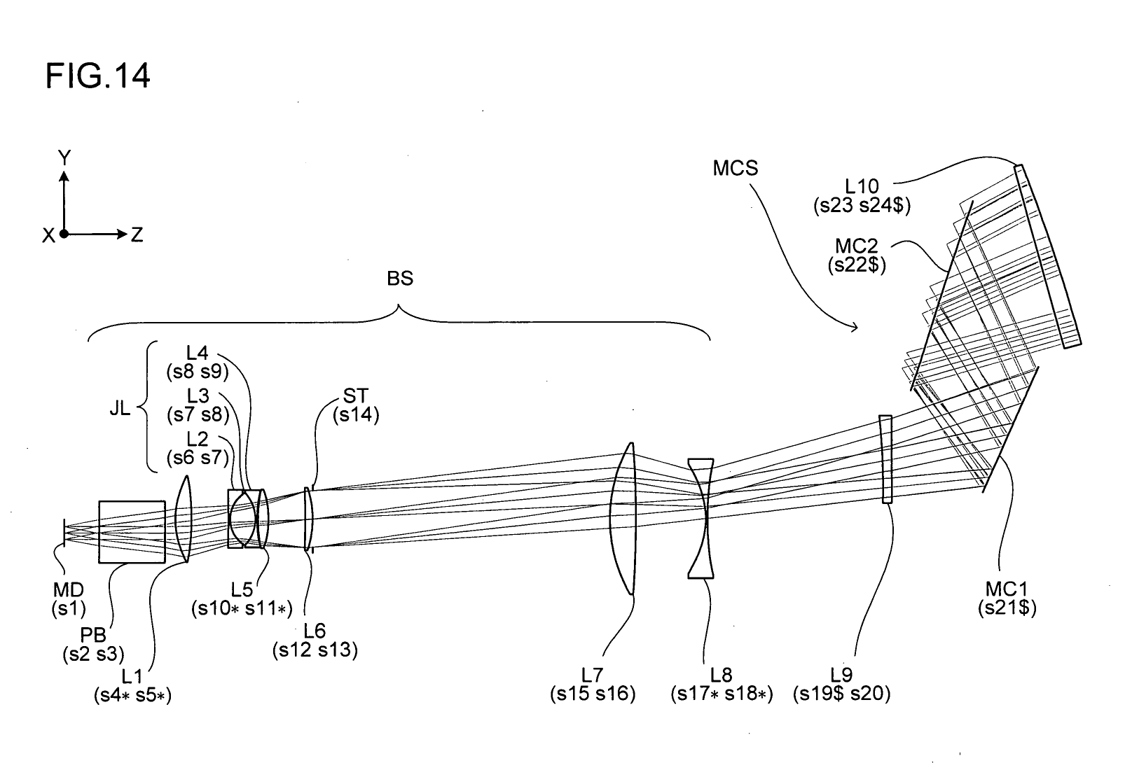

### [2-1-1. Refractive Optical Systems BS of Examples 2 and 3 (see FIGS. 9 and 14)]

First, the refractive optical systems BS of both Examples 2 and 3 have the following optical elements.
Prism block PB: A prism having at least two surfaces (s2 and 3). This prism block PB may play a role as a color integration prism or a PBS.
First lens L1: A positive lens convex on the both sides.
Joined lens JL: A lens having a second lens L2, a third lens L3, and a fourth lens L4 joined together with an adhesive bond or the like. The second lens L2 is a negative lens concave on the both sides, the third lens L3 is a positive lens convex on the both sides, and the lens L4 is a negative lens concave on the both sides.
Fifth lens L5: A positive lens convex on the both sides.
Sixth lens L6: A positive meniscus lens concave on the reduction side.
Optical aperture stop ST: An aperture stop which partially intercepts image light and is also indicated as s14.
Seventh lens L7: A positive lens convex on the both sides.
Eighth lens L8: A negative lens concave on the both sides.

### [2-1-2. Aberration Correcting Lenses of Examples 2 and 3 (see FIGS. 9 and 14)]

For the projection optical system unit PU of Example 2, between the refractive optical system BS and the curved mirror optical system MCS, the aberration correcting lens lies. Thus, this aberration correcting lens is located at the ninth position as a lens. Therefore, for Example 2, the aberration correcting lens is referred to as the ninth lens L9.

On the other hand, for the projection optical system unit PU of Example 3, between the refractive optical system BS and the curved mirror optical system MCS, one aberration correcting lens lies. Furthermore, also between the second curved mirror MC2 and the turning flat mirror MH, one aberration correcting lens lies. Thus, the first aberration correcting lens is located at the ninth position as a lens, and the second aberration correcting lens is located at the tenth position as a lens. Therefore, for Example 3, the aberration correcting lenses are referred to as the ninth lens L9 and the tenth lens L10.

### [2-1-3. Construction Data for Projectors of Examples 2 and 3]

Tables 14 to 42 show construction data for the projectors PD of Examples 2 and 3. Numerals in the tables represent the same as described above.

For the projector PD of Example 2, the curvature of a reflection surface s21$ of the first curved mirror MC1 is as follows:
Curvature {r(MC1)} of the reflection surface s21$ in the x-direction=−0.00195 (1/mm); and
Curvature of the reflection surface s21$ in the y-direction=0.00070 (1/mm)

For the projector PD of Example 2, the curvature of the reflection surface s22$ of the second curved mirror MC2 is as shown below:
Curvature {r(MC2)} of the reflection surface s22$ in the x-direction=0.00803(1/mm); and
Curvature of the reflection surface s22$ in the y-direction=−0.00054(1/mm)

For the projector PD of Example 2, the length (H) of the screen surface in the horizontal direction (HL) is “1161 (mm)”.

On the other hand, for the projector PD of Example 3, the curvature of the reflection surface s21$ of the first curved mirror MC1 is as shown below:
Curvature {r(MC1)} of the reflection surface s21$ in the x-direction=−0.00200(1/mm); and
Curvature of the reflection surface s21$ in the y-direction=0.00014(1/mm)

For the projector PD of Example 3, the curvature of the reflection surface s22$ of the second curved mirror MC2 is as shown below:
curvature {r(MC2)} of the reflection surface s22$ in the x-direction=0.00809(1/mm); and
curvature of the reflection surface s22$ in the y-direction=−0.00024(mm)

For the projector PD of Example 3, the length (H) of the screen surface in the horizontal direction (HL) is “1157(mm)”.

### [2-1-4. Spot Diagram and Distortion Diagram of Examples 2 and 3]

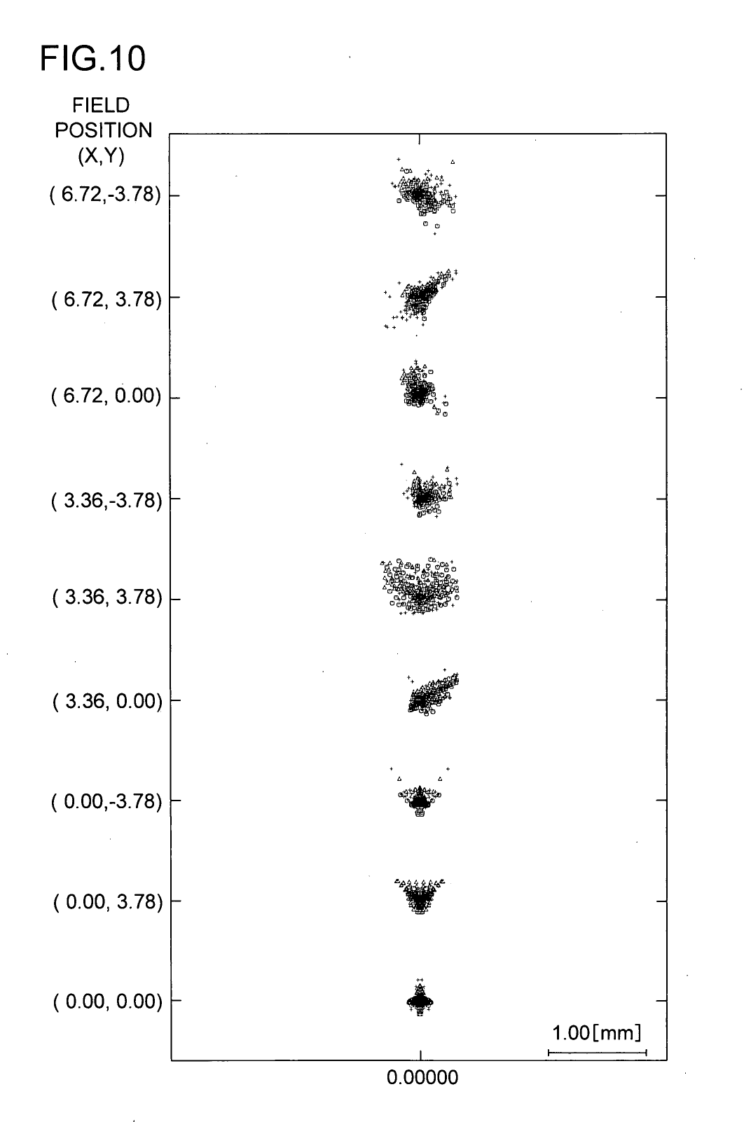

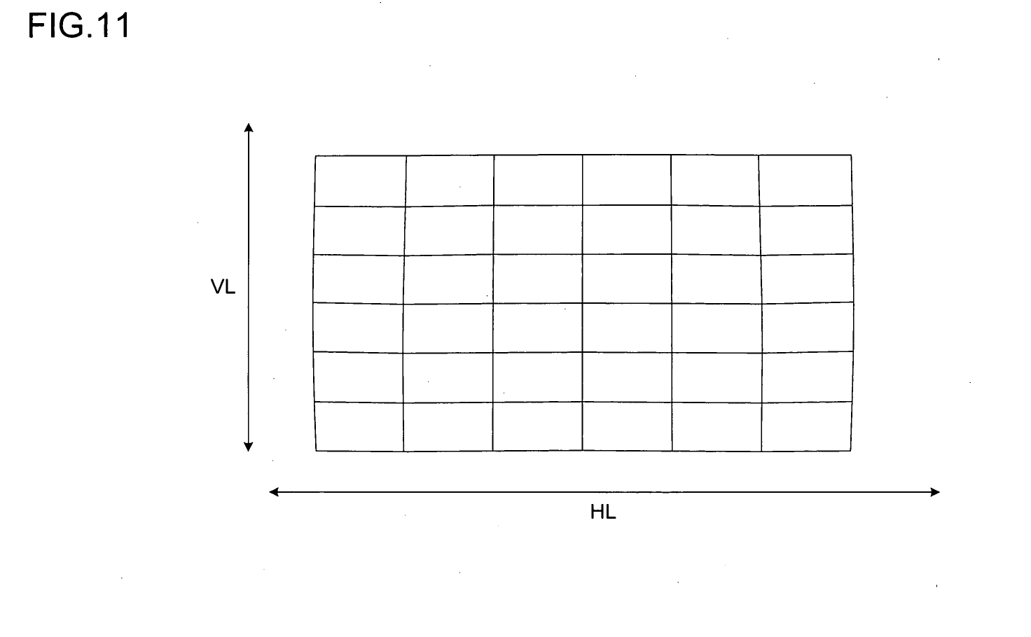

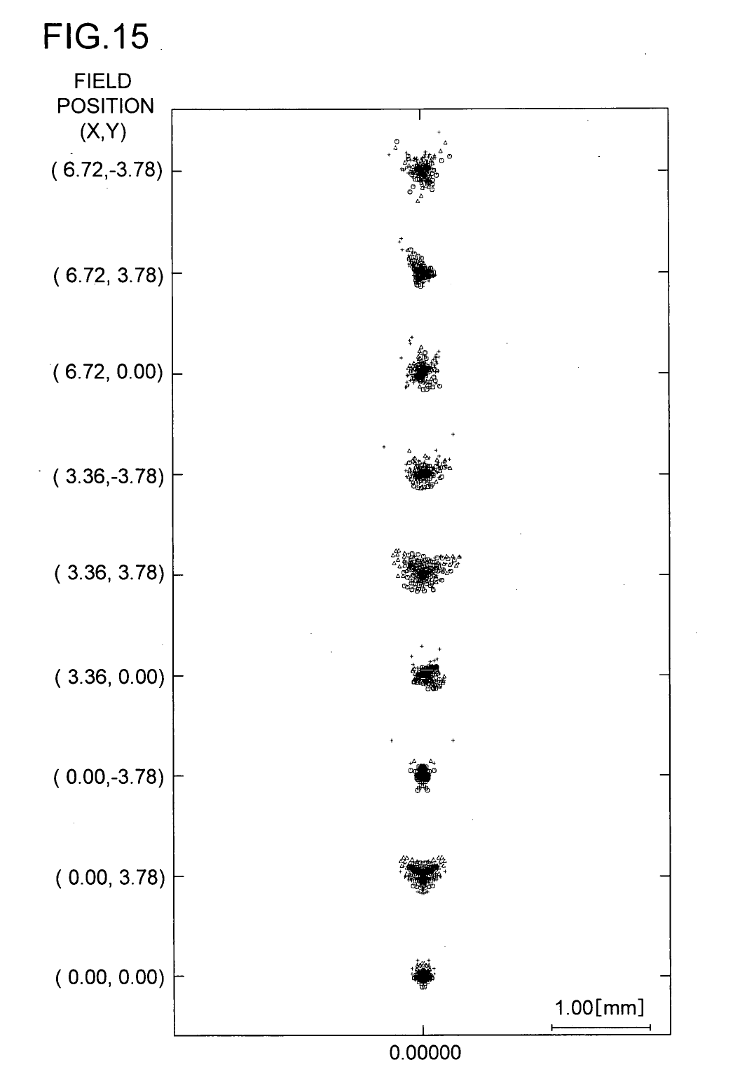

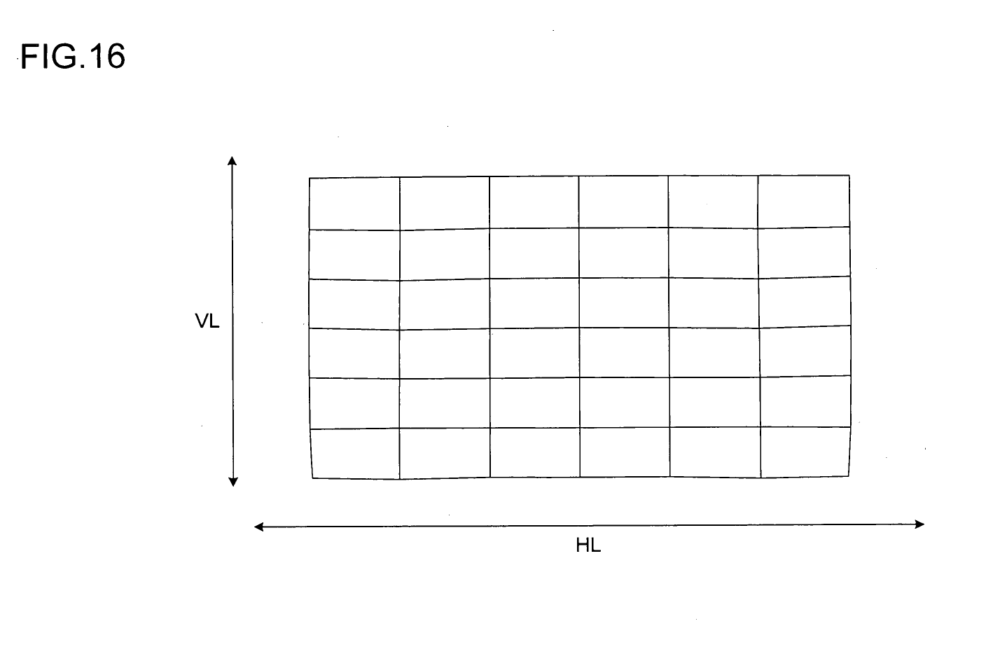

Spot diagrams and distortion diagrams for the projectors PD of Examples 2 and 3 are shown in FIGS. 10 and 11 (Example 2) and in FIGS. 15 and 16 (Example 3). Note that FIGS. 10 and 15 are expressed in the same manner as FIG. 5 and FIGS. 11 and 16 are expressed in the same manner as FIG. 6.

The object side F No. and image magnifications β(x) and β(y) in Examples 2 and 3 are as shown below.

[Projector PD of Example 2]

| | |
|---|---|
| Object side F No. | 2.56 |
| Image magnification β(x) | −85.8 |
| Image magnification β(y) | −85.8 |

[Projector PD of Example 3]

| | |
|---|---|
| Object side F No. | 2.57 |
| Image magnification β(x) | −85.8 |
| Image magnification β(y) | −85.8 |

### [2-2. One Example of Characteristics]

The projectors PD of Examples 2 and 3 have all the various characteristics described in the first embodiment. Therefore, the effects corresponding to these characteristics are also provided by the projectors PD of Examples 2 and 3.

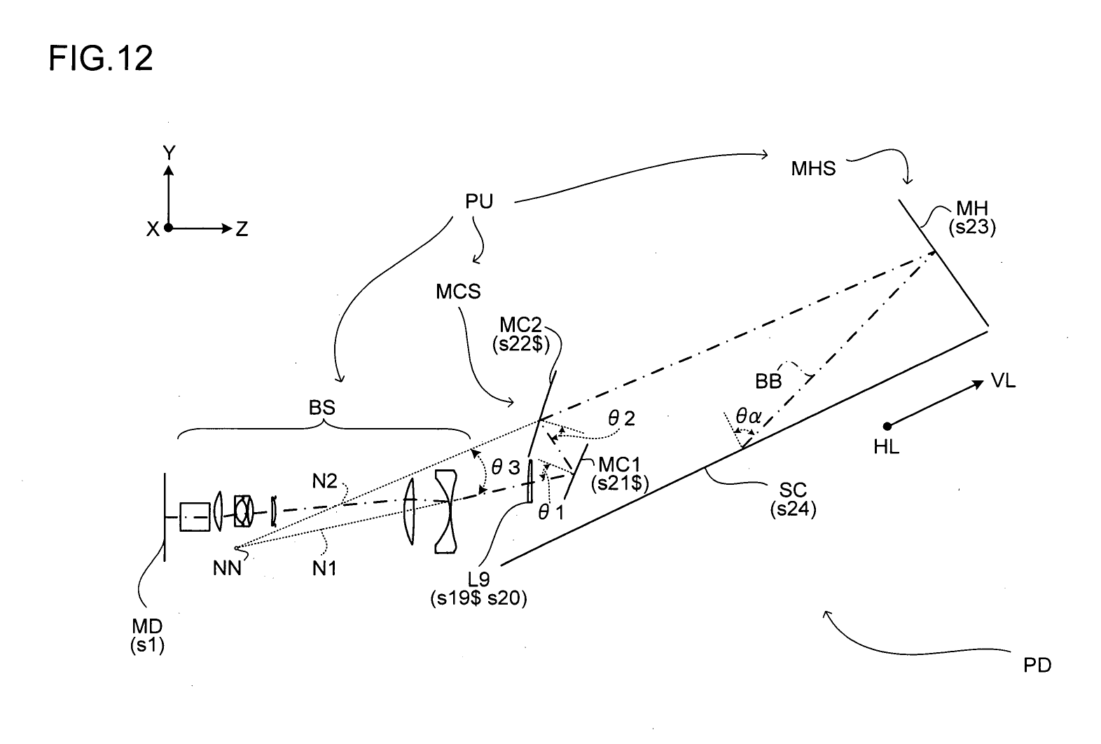

Thus, Table 43 shows results of Examples 2 and 3 in correspondence with the conditional formulas (1) to (6), together with the results of Example 1 for convenience. Moreover, for easier understanding of θα and θ1 to θ3 corresponding to Examples 2 and 3, the projectors PD with these angles specified are shown in FIGS. 12 (Example 2) and 17 (Example 3), respectively.

In the projector PD of Example 2, the projection optical system unit PU includes the aberration correcting lens(s). Then, for Example 2, the reduction side surface (s19$) of the aberration correcting lens (ninth lens L9) is a free-form surface. For Example 3, the reduction side surface (s19$) of the first aberration correcting lens (ninth lens L9) and an enlargement side surface (s24$) of the second aberration correcting lens (tenth lens L10) are free-form surface.

The presence of a lens with such a free-form surface permits easy correction of distortion, curvature of field, and the like occurring in the projection optical system unit PU. Thus, even if the power of the curved mirror MC included in the curved mirror optical system MCS becomes relatively large, situation such that various aberration remarkably appears accordingly does not occur.

An increase in the power of the curved mirror MC results in a relatively small size of the reflection surface of the curved mirror MC, thus permitting downsizing of the curved mirror optical system MCS itself. Furthermore, the downsizing of such a curved mirror MC results in cost reduction and easier manufacture accordingly.

### Other Embodiments

The invention is not limited to the embodiments described above, and thus various modifications are permitted within the range not deviating from the spirit of the invention.

For example, the refractive optical system BS included in the projection optical system unit PU may be either a centered refractive optical system or a decentered refractive optical system. However, the centered refractive optical system is easier to manufacture than the decentered refractive optical system, and thus cost reduction of the centered refractive optical system can be achieved more easily.

The number of curved mirrors MC included in the curved mirror optical system MCS is not limited to two and thus may be three or more. That is, a plurality of (at least two) curved mirrors MC may be included. In the interval between the curved mirrors, another optical element (lens or the like) may be located.

The number of turning mirror optical systems MHS is not limited to one. That is, the turning mirror optical system MHS formed of a single turning flat mirror MH as described above may be provided or a turning mirror optical system including a plurality of turning mirrors may be provided. That is, a turning mirror optical system including a turning mirror (not limited to a flat mirror) which can guides image light to the screen SC may be included.

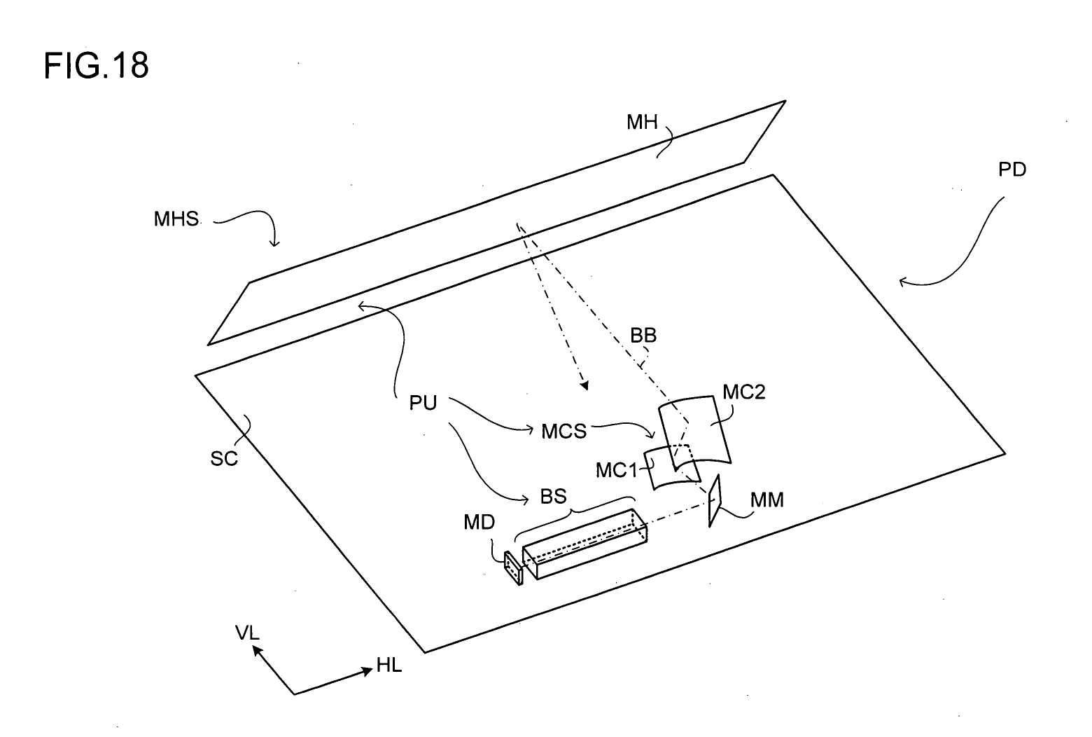

If the refractive optical system BS is located at such a position as to be hidden behind the screen surface, a chin portion is less likely to appear, thus achieving a small-size projector PD with a large screen, which is preferable. Thus, for example, as shown in FIG. 18, it is preferable that an optical path change element MM (for example, a flat mirror) which changes an optical path be provided on the optical path between the refractive optical system BS and the curved mirror optical system MCS (more specifically, the first curved mirror MC1), since the presence of such an optical path change element MM permits, as shown in FIG. 18, the refractive optical system BS to be located behind the screen surface by bending the optical path.

The position of this optical path change element MM is not limited to the optical path between the refractive optical system BS and the curved mirror optical system MCS. For example, the optical path change element MM may be located in the optical path of the refractive optical system BS. That is, the optical path change element MM may be located at a position that permits changing the optical path so that the optical element (the refractive optical system BS or the like) so located as to project from the screen surface can be guided to be behind the screen surface.

A projector PD appropriately combining the conditional formulas (1) to (6) can also be referred to as the present invention. The projector PD described above can also be expressed as follows.

An image projection apparatus provided with a projection optical system unit which performs projection (for example, enlarged projection) on a projection surface by guiding image light emitted from a light modulation element has a projection optical system unit including: a refractive optical system having an optical aperture stop; a curved mirror optical system having at least a first curved mirror and a second curved mirror which reflects light reflected via this first curved mirror; and an optical path change mirror optical system which changes the traveling direction of image light at least once.

If image light traveling from a center of a display surface of the light modulation element through a center of the optical aperture stop toward a center of the projection surface is a base ray, in such an image projection apparatus, the angle θα of incidence [°] of the base ray with respect to the projection surface satisfies conditional formula (1) below:

55<θα<76 Conditional formula (1).

Furthermore, the first curved mirror and the second curved mirror are located so that the optical path of the base ray reaching the first curved mirror and the optical path of the base ray leaving the second curved mirror do not intersect with each other, and further the first curved mirror is located between the second curved mirror and the projection surface.

In such a projection optical system unit of the image projection apparatus, a refractive optical system is included which reflects image light (that is, provides converging power and diverging power), thus permitting various aberration correction by use of this refractive power. For example, if image light is generated by integration of polychromatic light by a color integration prism or the like, chromatic aberration attributable to the color integration prism occurs, which is corrected by a refractive power.

Furthermore, the projection optical system unit of the image projection apparatus also includes the curved mirror optical system having a plurality of curved mirrors (first curved mirror and second curved mirror). Thus, the image projection apparatus corrects curvature of field, distortion, and the like by use of a reflection surface of a curved shape.

Moreover, the projection optical system unit of the image projection apparatus also includes the optical path change mirror optical system. Thus, the optical path extending from the light modulation element up to the projection surface changes (for example, is turned back) at least once. Thus, the projection optical system unit can never be so structured as to extend in one direction. As a result, such a projection optical system unit is designed to be compact.

Furthermore, if the conditional formula (1) is satisfied, the angle of a base ray entering the projection surface (angle of incidence) is relatively large and a member for guiding the base ray entering the projection surface and the projection surface are not separated excessively. Thus, due to this interval not excessively separating the two, the image projection apparatus is likely to be slim.

If image light is reflected by the second curved mirror after reflected by the first curved mirror (for example, if image light is reflected continuously by the first curved mirror and then the second curved mirror), the first curved mirror and the second curved mirror are located so that the optical path of the base ray extending reaching the first curved mirror and the optical path of the base ray leaving the second curved mirror do not intersect with each other.

Thus, the optical path extending from the refractive optical system up to the first curved mirror and the optical path extending from the second curved mirror up to the turning mirror optical system extend in one direction in substantially parallel to each other. Thus, designing the depth (thickness direction) of the image projection apparatus to be perpendicular with respect to this one direction slims down the image projection apparatus.

Furthermore, locating the first curved mirror between the second curved mirror and the projection surface locates the first curved mirror behind the projection surface. Thus, the refractive optical system which emits image light toward the first curved mirror, and the like, are also hidden by the projection surface. As a result, the optical element portion (referred to as a chin portion) projecting from the projection surface becomes relatively short.

As described above, the image projection apparatus can efficiently correct chromatic aberration and the like by having the refractive optical system and can efficiently correct curvature of field, distortion, and the like by having the curved mirror optical system, thus providing image light of high image quality. Furthermore, in such an image projection apparatus, through the adjusted, arrangement of the first curved mirror and the second curved mirror, the projection optical system unit does not extend in one direction, and further the chin portion is not projected. Thus, a slim image projection apparatus with a large screen and further with high image quality is achieved.

Moreover, it is preferable that the image projection apparatus satisfying the conditional formula (1) satisfy several conditional formulas for further slimming-down and even higher performance (further control of various aberration).

For example, it is preferable that the image projection apparatus satisfy, in addition to the conditional formula (1), conditional formula (2) below:

25<θ1<45 Conditional formula (2),

where
θ1: represents the angle [unit; °] of incident of a base ray with respect to the first curved mirror.

If the value of θ1 is equal to or smaller than the lower limit, for example, image light traveling from the refractive optical system to the first curved mirror is intercepted by the second curved mirror. Since the reflection surface of the first curved mirror and the refractive optical system may oppose each other, if the interval between these opposing members and the thickness direction of the image projection apparatus agree with each other, the thickness of the image projection apparatus is large.

On the other hand, if the value of θ1 is equal to or larger than the upper limit, for example, when the first curved mirror is located behind the projection surface, the refractive optical system which emits image light to this first curved mirror approaches the end of the projection surface, thus projecting from the projection surface (the refractive optical system is no longer hidden behind the projection surface). Moreover, the angle of incidence of image light on the first curved mirror is relatively large, thus causing distortion of a trapezoidal shape.

However, within the range of the conditional formula (2), the problems as described do not occur. Thus, slimming-down and higher performance of the image projection apparatus can be achieved.

Further, it is preferable that the image projection apparatus satisfy conditional formula (2a):

30<θ1<40 Conditional formula (2a).

It is preferable that the image projection apparatus satisfy, in addition to conditional formula (1), conditional formula (3) below:

30<θ2<50 Conditional formula (3),

where
θ2: represents the angle [unit; °] of incidence of the base ray with respect to the second curved mirror.

If the value of θ2 is equal to or smaller than the lower limit, for example, the second curved mirror and the first curved mirror approach each other too closely, and part of image light emitted from the second curved mirror is intercepted by the first curved mirror. Moreover, if the first curved mirror closely approaches the second curved mirror and also if the first curved mirror is located behind the projection surface, the refractive optical system approaches the end of the projection surface and projects therefrom.

On the other hand, if the value of θ2 is equal to or larger than the upper limit, for example, the reflection surface of the second curved mirror and the reflection surface of the first curved mirror oppose each other, and image light traveling from the refractive optical system to the first curved mirror is intercepted by the second curved mirror. Moreover, the angle of incidence of the image light on the second curved mirror is relatively large, thus causing distortion of a trapezoidal shape.

However, within the range of the conditional formula (3), the problems described above do not occur. Thus, slimming-down and higher performance of the image projection apparatus can be achieved.

Further, it is preferable that the image projection apparatus satisfy conditional formula (3a) below:

35<θ2<45 Conditional formula (3a).

Needless to say, with the image projection apparatus satisfying the both conditional formulas (2) and (3) in addition to the conditional formula (1), effect of achieving slimming-down and higher performance is enhanced.

It is preferable that the image projection apparatus satisfy, in addition to the conditional formula (1), conditional formula (4) below:

0<03<20 Conditional formula (4),

where
θ3 represents the angle [unit; °] formed by a direction of the base ray reaching the first curved mirror and a direction of the base ray leaving the second curved mirror.

If the value of θ3 is equal to or larger than the upper limit, for example, the refractive optical system which emits image light to the first curved mirror separates from the first curved mirror located behind the projection surface (that is, the refractive optical system separates from the projection surface). Thus, if the thickness of the image projection apparatus and the interval from the refractive optical system to the projection surface agree with each other, the thickness of the image projection apparatus increases in proportion to the value of θ3. Thus, the image projection apparatus is slimmed down within the range of this conditional formula (4).

An image projection apparatus satisfying the conditional formula (2) in addition to the conditional formulas (1) and (4); an image projection apparatus satisfying the conditional formula (3) in addition to the conditional formulas (1) and (4); and further an image projection apparatus satisfying the conditional formulas (2) and (3) in addition to the conditional formulas (1) and (4) are preferable.

The image projection apparatus achieves enlarged projection of image light by using the power of the curved mirror. Thus, appropriately setting the power of the curved mirror also permits achieving higher performance and slimming-down. Thus, for example, an image projection apparatus satisfying conditional formula (5) below in addition to the conditional formula (1) is preferable.

−3.3<H×r(MC1)<−1.0 Conditional formula (5),

where
H: represents the length [unit; mm] in one direction (horizontal direction) of a rectangular coordinate system defined on the projection surface; and
r(MC1): represents the curvature [unit; 1/mm], at the point of a reflection surface of the first curved mirror MC1 where the base ray reaches, in the same direction as a horizontal direction (HL) possessed by this reflection surface (if the reflection surface is concave, the sign of the curvature value is “negative”).

For example, if the value of H×r(MC1) is equal to or smaller than the lower limit, the positive power of the first curved mirror in the same direction as the horizontal direction of the projection surface is relatively strong, thereby causing curvature of field, distortion, and the like.

On the other hand, if the value of H×r(MC1) is equal to or larger than the upper limit, the positive power of the first curved mirror is relatively weak, and the width of a luminous flux of image light traveling from the first curved mirror to the second curved mirror widens. Thus, to receive relatively widening image light, the size of the reflection surface of the second curved mirror inevitably needs to be increased even if it results in cost increase.

However, within the range of the conditional formula (5), the problem as described above does not occur. Thus, the image projection apparatus can be further slimmed down and manufactured at even lower cost while providing high performance.

Moreover, an image projection apparatus satisfying the conditional formula (2) in addition to the conditional formulas (1) and (5); an image projection apparatus satisfying the conditional formula (3) in addition to the conditional formulas (1) and (5); and further an image projection apparatus satisfying the conditional formulas (2) and (3) in addition to the conditional formulas (1) and (5) are also preferable.

It is preferable that the image projection apparatus satisfy, in addition to the conditional formula (1), conditional formula (6) below:

6.0<H×r(MC2)<11.0 Conditional formula (6),

where
H: represents the length [unit; mm] in one direction (horizontal direction) of a rectangular coordinate system defined on the projection surface; and
r(MC2): represents the curvature [unit; 1/mm], at the point of a reflection surface of the second curved mirror where the base ray reaches, in the same direction as a horizontal direction (HL) possessed by this reflection surface (if the reflection surface is convex, the sign of the curvature value is “positive”).

For example, if the value of H×r(MC2) is equal to or smaller than the lower limit, the negative power of the second curved mirror in the same direction as the horizontal direction of the projection surface is relatively weak, which results in failure to satisfactorily enlarge image light (to widen the angle thereof). In such a case, enlarged projection of image light can be achieved by increasing the size of the reflection surface of the second curved mirror, but this leads to thickening and further cost increase of the second curved mirror and eventually the image projection apparatus.

On the other hand, if the value of H×r(MC2) is equal to or larger than the upper limit, the negative power of the second curved mirror in the same direction as the horizontal direction of the projection surface is relatively strong, thereby causing curvature of field, distortion, and the like.

However, within the range of H×r(MC2), the problem as described above does not occur. Thus, a slim, low-price image projection apparatus with higher performance can be achieved. Needless to say, satisfying the both conditional formulas (5) and (6) permits enhancing the effect of achieving a low-price, slim image projection apparatus with higher performance.

Moreover, an image projection apparatus satisfying the conditional formula (2) in addition to the conditional formulas (1) and (6); an image projection apparatus satisfying the conditional formula (3) in addition to the conditional formulas (1) and (6); and further an image projection apparatus satisfying the conditional formulas (2) and (3) in addition to the conditional formulas (1) and (6) are preferable.

The image projection apparatus may include an optical path change element which changes the optical path of image light so as to reliably locate the refractive optical system behind the projection surface. For example, on the optical path in the refractive optical system or on the optical path extending from the refractive optical system to the curved mirror optical system, an optical path change element may be provided. Needless to say, the present invention also includes an image projection apparatus including the projection optical system unit described above and the light modulation element.

The detailed embodiments, examples, or the like provided in the above description just clarify the contents of technology provided by the invention. Therefore, the invention should not be interpreted narrowly by being limited to the detailed examples, and thus various modifications can be made within the range of the appended claims.

TABLE 1
Example 1

| | | |
|---|---|---|
| MD | s1 | r1 |
| | | ∞ |

TABLE 2
Example 1

| | |
|---|---|
| d1 | 20.300000 |

| | | | | |
|---|---|---|---|---|
| PB | N1 | ν1 | s2 | r2 |
| | 1.51680 | 65.261 | | ∞ |

| | |
|---|---|
| d2 | 38.220000 |

| | |
|---|---|
| s3 | r3 |
| | ∞ |

TABLE 3
Example1

| L1 | N2 | ν2 | s4* | r4 |
|---|---|---|---|---|
| | 1.79850 | 22.600 | | 40.67650 |

| Decentering Displacements | | | | | |
|---|---|---|---|---|---|
| XDE | 0.000000 | YDE | 8.000000 | ZDE | 64.520000 |
| ADE | 0.000000 | BDE | 0.000000 | CDE | 0.000000 |

| Aspherical Surface Coefficients | |
|---|---|
| K | 0.000000 |

| | | | |
|---|---|---|---|
| A | −0.238005 E−05 | B | −0.392839 E−09 |
| C | −0.725642 E−12 | D | −0.134112 E−14 |

| | |
|---|---|
| d4 | 10.091714 |

| | |
|---|---|
| s5* | r5 |

| −138.23722 | | | |
|---|---|---|---|
| Aspherical Surface Coefficients | | | |
| K | 0.000000 | | |
| A | 0.107881 E−05 | B | −0.626449 E−09 |
| C | −0.760727 E−12 | D | −0.461959 E−16 |

TABLE 4
Example 1

| | |
|---|---|
| d5 | 16.880495 |

| | | | | | |
|---|---|---|---|---|---|
| JL | L2 | N3 | ν3 | s6 | r6 |
| | | 1.84727 | 25.737 | | −518.01028 |

| | |
|---|---|
| d6 | 1.000000 |

| | | | s7 | r7 |
|---|---|---|---|---|
| L3 | N4 | ν4 | | 17.18744 |

| | | | |
|---|---|---|---|
| 1.57222 | 61.087 | d7 | 13.880275 |

| | | | s8 | r8 |
|---|---|---|---|---|
| L4 | N5 | ν5 | | −21.87667 |

| | | | |
|---|---|---|---|
| 1.80042 | 22.791 | d8 | 1.000002 |

| | |
|---|---|
| s9 | r9 |
| | 56.58234 |

TABLE 5
Example 1

| | |
|---|---|
| d9 | 0.700000 |

| | | | | |
|---|---|---|---|---|
| L5 | N6 | ν6 | s10* | r10 |
| | 1.48749 | 70.440 | | 68.97734 |
| | | | | Aspherical Surface Coefficients |

| | |
|---|---|
| K | 0.000000 |

| | | | |
|---|---|---|---|
| A | −0.106606 E−05 | B | 0.803977 E−08 |
| C | −0.155652 E−10 | D | 0.902135 E−13 |

| | |
|---|---|
| d10 | 5.477076 |

| | |
|---|---|
| s11* | r11 |
| | −80.51971 |
| | Aspherical Surface Coefficients |

| | |
|---|---|
| K | 0.000000 |

| | | | |
|---|---|---|---|
| A | −0.603631 E−05 | B | −0.484295 E−08 |
| C | −0.206914 E−10 | D | 0.961568 E−14 |

TABLE 6
Example 1

| | |
|---|---|
| d11 | 20.745012 |

| | | | | |
|---|---|---|---|---|
| L6 | N7 | ν7 | s12 | r12 |
| | 1.79850 | 22.600 | | −149.92848 |

| | |
|---|---|
| d12 | 4.777169 |

| | |
|---|---|
| s13 | r13 |
| | −43.83376 |

TABLE 7
Example 1

| | |
|---|---|
| d13 | 0.100130 |

| | | |
|---|---|---|
| ST | s14 | r14 |
| | | ∞ |

TABLE 8
Example 1

| | |
|---|---|
| d14 | 158.594992 |

| | | | | |
|---|---|---|---|---|
| L7 | N8 | ν8 | s15 | r15 |
| | 1.57099 | 58.515 | | 89.90980 |

| | |
|---|---|
| d15 | 15.961083 |

| | |
|---|---|
| s16 | r16 |
| | −257.60557 |

TABLE 9
Example 1

| | |
|---|---|
| d16 | 45.238248 |

| | | | | |
|---|---|---|---|---|
| L8 | N9 | ν9 | s17* | r17 |
| | 1.74646 | 51.843 | | −45.69435 |
| | | | | Aspherical Surface Coefficients |

| | |
|---|---|
| K | 0.000000 |

| | | | |
|---|---|---|---|
| A | 0.204519 E−05 | B | −0.106335 E−08 |
| C | 0.888746 E−12 | D | −0.917121 E−16 |

| | |
|---|---|
| d17 | 11.033805 |

| | |
|---|---|
| s18* | r18 |
| | −2242.63032 |
| | Aspherical Surface Coefficients |

| | |
|---|---|
| K | 0.000000 |

| | | | |
|---|---|---|---|
| A | 0.826122 E−06 | B | −0.112359 E−08 |
| C | 0.564675 E−12 | D | −0.112086 E−15 |

TABLE 10
Example 1

| | | |
|---|---|---|
| MC1 | s19$ | r19 |
| | | ∞ |
| | | Decentering Displacements |

| XDE | 0.000000 | YDE | 8.000000 | ZDE | 630.051800 |
|---|---|---|---|---|---|
| ADE | −15.955617 | BDE | 0.000000 | CDE | 0.000000 |
| Free-form Surface Coefficients | | | | | |
| C(0, 1) | 2.0941 E−01 | C(2, 0) | −1.7855 E−03 | C(0, 2) | −4.5638 E−03 |
| C(2, 1) | −1.4513 E−06 | C(0, 3) | 1.4381 E−04 | C(4, 0) | −1.9973 E−08 |
| C(2, 2) | 6.2741 E−07 | C(0, 4) | −2.8481 E−06 | C(4, 1) | 4.5194 E−09 |
| C(2, 3) | −1.2328 E−08 | C(0, 5) | 3.5913 E−08 | C(6, 0) | 1.4501 E−11 |
| C(4, 2) | −1.3965 E−10 | C(2, 4) | 1.2507 E−10 | C(0, 6) | −2.7036 E−10 |
| C(6, 1) | −7.1956 E−13 | C(4, 3) | 1.3678 E−12 | C(2, 5) | −6.7347 E−13 |
| C(0, 7) | 1.0276 E−12 | C(8, 0) | −7.0967 E−16 | C(6, 2) | 1.7432 E−14 |
| C(4, 4) | −1.9356 E−15 | C(2, 6) | 2.2346 E−17 | C(0, 8) | −4.9866 E−16 |
| C(8, 1) | −9.4695 E−19 | C(6, 3) | −1.7393 E−16 | C(4, 5) | −2.9304 E−17 |
| C(2, 7) | 2.1645 E−17 | C(0, 9) | −8.6622 E−18 | C(10, 0) | 2.7863 E−20 |
| C(8, 2) | 6.1248 E−20 | C(6, 4) | 5.5106 E−19 | C(4, 6) | 9.4963 E−20 |
| C(2, 8) | −8.0985 E−20 | C(0, 10) | 1.8663 E−20 | | |

TABLE 11
Example 1

| | | |
|---|---|---|
| MC2 | s20$ | r20 |
| | | ∞ |
| | | Decentering Displacements |

| XDE | 0.000000 | YDE | 45.002336 | ZDE | 570.631037 |
|---|---|---|---|---|---|
| ADE | −6.777569 | BDE | 0.000000 | CDE | 0.000000 |
| Free-form Surface Coefficients | | | | | |
| C(0, 1) | 3.0216 E−01 | C(2, 0) | −1.5118 E−02 | C(0, 2) | −1.1628 E−03 |
| C(2, 1) | 2.4030 E−04 | C(0, 3) | 2.4680 E−06 | C(4, 0) | 5.3010 E−07 |
| C(2, 2) | −1.8730 E−06 | C(0, 4) | 3.6094 E−08 | C(4, 1) | −2.0630 E−08 |
| C(2, 3) | 6.3070 E−09 | C(0, 5) | −1.4658 E−10 | C(6, 0) | 1.8147 E−10 |
| C(4, 2) | 2.0519 E−10 | C(2, 4) | 1.8695 E−12 | C(0, 6) | −1.0060 E−13 |
| C(6, 1) | −1.5306 E−12 | C(4, 3) | −5.2236 E−13 | C(2, 5) | −6.2877 E−14 |
| C(0, 7) | 1.5074 E−16 | C(8, 0) | −2.6173 E−14 | C(6, 2) | −9.1353 E−15 |
| C(4, 4) | −1.3959 E−15 | C(2, 6) | 1.4514 E−17 | C(0, 8) | −9.3963 E−18 |
| C(8, 1) | 4.6988 E−16 | C(6, 3) | 8.2309 E−17 | C(4, 5) | 6.5434 E−18 |
| C(2, 7) | 8.0209 E−19 | C(0, 9) | 1.2482 E−19 | C(10, 0) | −7.6516 E−19 |
| C(8, 2) | −1.6453 E−18 | C(6, 4) | −1.0607 E−19 | C(4, 6) | −4.3775 E−21 |
| C(2, 8) | −1.7621 E−21 | C(0, 10) | −3.1883 E−22 | | |

TABLE 12
Example 1

| | | |
|---|---|---|
| MH | s21 | r21 |
| | | ∞ |

| Decentering Displacements | | | | | |
|---|---|---|---|---|---|
| XDE | 0.000000 | YDE | 281.193736 | ZDE | 1282.469236 |
| ADE | 30.523247 | BDE | 0.000000 | CDE | 0.000000 |

TABLE 13
Example 1

| | | |
|---|---|---|
| SC | s22 | r22 |
| | | ∞ |

| Decentering Displacements | | | | | |
|---|---|---|---|---|---|
| XDE | 0.000000 | YDE | 268.708103 | ZDE | 1268.934134 |
| ADE | 112.040255 | BDE | 0.000000 | CDE | 0.000000 |

TABLE 14
Example 2

| | | |
|---|---|---|
| MD | s1 | r1 |
| | | ∞ |

TABLE 15
Example 2

| | |
|---|---|
| d1 | 20.300000 |

| | | | | |
|---|---|---|---|---|
| PB | N1 | ν1 | s2 | r2 |
| | 1.51680 | 65.261 | | ∞ |

| | |
|---|---|
| d2 | 38.220000 |

| | |
|---|---|
| s3 | r3 |
| | ∞ |

TABLE 16
Example 2

| | | | | |
|---|---|---|---|---|
| L1 | N2 | ν2 | s4* | r4 |
| | 1.79850 | 22.600 | | 42.22400 |
| | | | | Decentering Displacements |

| | | | | | |
|---|---|---|---|---|---|
| XDE | 0.000000 | YDE | 8.000000 | ZDE | 64.520000 |
| ADE | 0.000000 | BDE | 0.000000 | CDE | 0.000000 |

| Aspherical Surface Coefficients | |
|---|---|
| K | 0.000000 |

| | | | |
|---|---|---|---|
| A | −0.264776 E−05 | B | 0.673056 E−09 |
| C | −0.136420 E−11 | D | −0.150571 E−14 |

| | |
|---|---|
| d4 | 9.840469 |

| | |
|---|---|
| s5* | r5 |
| | −164.02246 |
| | Aspherical Surface Coefficients |

| | |
|---|---|
| K | 0.000000 |

| | | | |
|---|---|---|---|
| A | −0.380942 E−07 | B | 0.124181 E−08 |
| C | −0.268586 E−11 | D | 0.430699 E−15 |

TABLE 17
Example 2

| | |
|---|---|
| d5 | 16.740196 |

| | | | | | |
|---|---|---|---|---|---|
| JL | L2 | N3 | ν3 | s6 | r6 |
| | | 1.84766 | 27.130 | | −13881.78217 |

| | |
|---|---|
| d6 | 1.000000 |

| | | | s7 | r7 |
|---|---|---|---|---|
| L3 | N4 | ν4 | | 18.37317 |

| | | | |
|---|---|---|---|
| 1.57268 | 61.050 | d7 | 14.347785 |

| | | | s8 | r8 |
|---|---|---|---|---|
| L4 | N5 | ν5 | | −23.41241 |

| | | | |
|---|---|---|---|
| 1.84702 | 24.922 | d8 | 1.000000 |

| | |
|---|---|
| s9 | r9 |
| | 61.28300 |

TABLE 18
Example 2

| | |
|---|---|
| d9 | 0.600000 |

| | | | | |
|---|---|---|---|---|
| L5 | N6 | ν6 | s10* | r10 |
| | 1.54744 | 63.275 | | 67.85220 |
| | | | | Aspherical Surface Coefficients |

| | |
|---|---|
| K | 0.000000 |

| | | | |
|---|---|---|---|
| A | −0.126080 E−05 | B | 0.106035 E−07 |
| C | −0.231283 E−10 | D | 0.477215 E−13 |

| | |
|---|---|
| d10 | 6.695727 |

| | |
|---|---|
| s11* | r11 |
| | −54.09168 |
| | Aspherical Surface Coefficients |

| | |
|---|---|
| K | 0.000000 |

| | | | |
|---|---|---|---|
| A | −0.485634 E−05 | B | −0.171330 E−08 |
| C | −0.149920 E−10 | D | 0.159343 E−15 |

TABLE 19
Example 2

| | |
|---|---|
| d11 | 25.009758 |

| | | | | |
|---|---|---|---|---|
| L6 | N7 | ν7 | s12 | r12 |
| | 1.79850 | 22.600 | | −205.46238 |

| | |
|---|---|
| d12 | 4.081635 |

| | |
|---|---|
| s13 | r13 |
| | −55.08295 |

TABLE 20
Example 2

| | |
|---|---|
| d13 | 0.100000 |

| | | |
|---|---|---|
| ST | s14 | r14 |
| | | ∞ |

TABLE 21
Example 2

| | |
|---|---|
| d14 | 165.645323 |

| | | | | |
|---|---|---|---|---|
| L7 | N8 | ν8 | s15 | r15 |
| | 1.75575 | 51.352 | | 97.75964 |

| | |
|---|---|
| d15 | 12.646645 |

| | |
|---|---|
| s16 | r16 |
| | −546.62042 |

TABLE 22
Example 2

| | |
|---|---|
| d16 | 46.772461 |

| | | | | |
|---|---|---|---|---|
| L8 | N9 | ν9 | s17* | r17 |
| | 1.80257 | 44.708 | | −62.88183 |
| | | | | Aspherical Surface Coefficients |

| | |
|---|---|
| K | 0.000000 |

| | | | |
|---|---|---|---|
| A | −0.254856 E−05 | B | 0.128380 E−08 |
| C | 0.733014 E−12 | D | −0.383064 E−15 |

| | |
|---|---|
| d17 | 1.000000 |

| | |
|---|---|
| s18* | r18 |
| | 100.58373 |
| | Aspherical Surface Coefficients |

| | |
|---|---|
| K | 0.000000 |

| | | | |
|---|---|---|---|
| A | −0.255677 E−05 | B | 0.984954 E−09 |
| C | 0.267836 E−12 | D | −0.171462 E−15 |

TABLE 23
Example 2

| | |
|---|---|
| d18 | 100.000000 |

| | | | | |
|---|---|---|---|---|
| L9 | N10 | ν10 | s19$ | r19 |
| | 1.49270 | 57.491 | | ∞ |
| | | | | Free-form Surface Coefficients |

| | | | | | |
|---|---|---|---|---|---|
| C(0, 1) | −4.6533 E−03 | C(2, 0) | −2.2032 E−04 | C(0, 2) | −1.5293 E−04 |
| C(2, 1) | 3.7296 E−05 | C(0, 3) | 2.8222 E−05 | C(4, 0) | 3.3854 E−07 |
| C(2, 2) | −2.2570 E−06 | C(0, 4) | −2.4956 E−07 | C(4, 1) | −1.6122 E−09 |
| C(2, 3) | 1.0490 E−07 | C(0, 5) | −3.8098 E−08 | C(6, 0) | −3.2941 E−10 |
| C(4, 2) | −3.2111 E−10 | C(2, 4) | −2.5936 E−09 | C(0, 6) | 1.6687 E−09 |
| C(6, 1) | 2.1305 E−11 | C(4, 3) | 5.8544 E−12 | C(2, 5) | 3.3743 E−11 |
| C(0, 7) | −2.5854 E−11 | C(8, 0) | −2.9007 E−14 | C(6, 2) | −6.1890 E−13 |
| C(4, 4) | 1.5752 E−13 | C(2, 6) | −2.4244 E−13 | C(0, 8) | 1.1555 E−13 |
| C(8, 1) | 8.5378 E−16 | C(6, 3) | 6.9714 E−15 | C(4, 5) | −4.2393 E−15 |
| C(2, 7) | 1.4242 E−15 | C(0, 9) | 8.4109 E−16 | C(10, 0) | 1.4289 E−17 |
| C(8, 2) | −2.0060 E−18 | C(6, 4) | −3.1683 E−17 | C(4, 6) | 2.5578 E−17 |
| C(2, 8) | −7.5805 E−18 | C(0, 10) | −7.1253 E−18 | | |

| | |
|---|---|
| d19 | 5.000000 |

| | |
|---|---|
| s20 | r20 |
| | −5294.24720 |

TABLE 24
Example 2

| | | |
|---|---|---|
| MC1 | s12$ | r21 |
| | | ∞ |
| | | Decentering Displacements |

| XDE | 0.000000 | YDE | 8.000000 | ZDE | 510.000000 |
|---|---|---|---|---|---|
| ADE | −19.3725141 | BDE | 0.000000 | CDE | 0.000000 |
| Free-form Surface Coefficients | | | | | |
| C(0, 1) | 8.2095 E−02 | C(2, 0) | −1.9138 E−03 | C(0, 2) | −2.5919 E−03 |
| C(2, 1) | 1.3017 E−05 | C(0, 3) | 1.0102 E−04 | C(4, 0) | 1.9673 E−08 |
| C(2, 2) | 2.1682 E−07 | C(0, 4) | −2.6362 E−06 | C(4, 1) | 1.0602 E−08 |
| C(2, 3) | 1.6245 E−09 | C(0, 5) | 4.3130 E−08 | C(6, 0) | 2.2350 E−11 |
| C(4, 2) | −4.7625 E−10 | C(2, 4) | −1.5638 E−10 | C(0, 6) | −3.8986 E−10 |
| C(6, 1) | −9.8660 E−13 | C(4, 3) | 5.6693 E−12 | C(2, 5) | 1.5191 E−12 |
| C(0, 7) | 1.3677 E−12 | C(8, 0) | −2.5567 E−14 | C(6, 2) | 6.2577 E−14 |
| C(4, 4) | 1.7750 E−14 | C(2, 6) | 3.1142 E−15 | C(0, 8) | 5.7555 E−15 |
| C(8, 1) | 1.8383 E−16 | C(6, 3) | −1.0881 E−15 | C(4, 5) | −6.3661 E−16 |
| C(2, 7) | −9.1124 E−17 | C(0, 9) | −6.7335 E−17 | C(10, 0) | 4.4651 E−18 |
| C(8, 2) | −1.7271 E−18 | C(6, 4) | 5.5121 E−18 | C(4, 6) | 2.6551 E−18 |
| C(2, 8) | 2.6310 E−19 | C(0, 10) | 1.7426 E−19 | | |

TABLE 25
Example 2

| | | |
|---|---|---|
| MC2 | s22$ | r22 |
| | | ∞ |
| | | Decentering Displacements |

| XDE | 0.000000 | YDE | 45.107170 | ZDE | 457.047100 |
|---|---|---|---|---|---|
| ADE | 4.258892 | BDE | 0.000000 | CDE | 0.000000 |
| Free-form Surface Coefficients | | | | | |
| C(0, 1) | 5.5301 E−01 | C(2, 0) | −1.7477 E−02 | C(0, 2) | −3.0516 E−03 |
| C(2, 1) | 4.0303 E−04 | C(0, 3) | 8.6865 E−06 | C(4, 0) | 6.6708 E−07 |
| C(2, 2) | −4.7497 E−06 | C(0, 4) | 3.0779 E−07 | C(4, 1) | −2.8140 E−08 |
| C(2, 3) | 2.5321 E−08 | C(0, 5) | −3.7841 E−09 | C(6, 0) | −1.9419 E−10 |
| C(4, 2) | 2.7471 E−10 | C(2, 4) | 1.0993 E−11 | C(0, 6) | 1.5792 E−11 |
| C(6, 1) | 1.4444 E−11 | C(4, 3) | 2.2250 E−13 | C(2, 5) | −7.6802 E−13 |
| C(0, 7) | 1.1807 E−14 | C(8, 0) | −7.7475 E−14 | C(6, 2) | −2.5318 E−13 |
| C(4, 4) | −9.7883 E−15 | C(2, 6) | 2.2684 E−15 | C(0, 8) | −2.9798 E−16 |
| C(8, 1) | 1.2298 E−15 | C(6, 3) | 1.6582 E−15 | C(4, 5) | 1.6554 E−18 |
| C(2, 7) | 7.2014 E−18 | C(0, 9) | 6.8754 E−19 | C(10, 0) | 4.2262 E−18 |
| C(8, 2) | −6.9756 E−18 | C(6, 4) | −3.3844 E−18 | C(4, 6) | 1.1420 E−19 |
| C(2, 8) | −3.5714 E−20 | C(0, 10) | −2.1221 E−23 | | |

TABLE 26
Example 2

| | | |
|---|---|---|
| MH | s23 | r23 |
| | | ∞ |
| | | Decentering Displacements |

| | | | | | |
|---|---|---|---|---|---|
| XDE | 0.000000 | YDE | 352.797780 | ZDE | 992.301018 |
| ADE | 34.736865 | BDE | 0.000000 | CDE | 0.000000 |

TABLE 27
Example 2

| | | |
|---|---|---|
| SC | s24 | r24 |
| | | ∞ |
| | | Decentering Displacements |

| | | | | | |
|---|---|---|---|---|---|
| XDE | 0.000000 | YDE | −120.118624 | ZDE | 318.922005 |
| ADE | 116.254955 | BDE | 0.000000 | CDE | 0.000000 |

TABLE 28
Example 3

| | | |
|---|---|---|
| MD | s1 | r1 |
| | | ∞ |

TABLE 29
Example 3

| | |
|---|---|
| d1 | 20.300000 |

| | | | | |
|---|---|---|---|---|
| PB | N1 | ν1 | s2 | r2 |
| | 1.53775 | 64.232 | | ∞ |

| | |
|---|---|
| d2 | 38.220000 |

| | |
|---|---|
| s3 | r3 |
| | ∞ |

TABLE 30
Example 3

| | | | | |
|---|---|---|---|---|
| L1 | N2 | ν2 | s4* | r4 |
| | 1.79837 | 22.606 | | 47.35629 |
| | | | | Decentering Displacements |

| | | | | | |
|---|---|---|---|---|---|
| XDE | 0.000000 | YDE | 8.000000 | ZDE | 64.520000 |
| ADE | 0.000000 | BDE | 0.000000 | CDE | 0.000000 |

| Aspherical Surface Coefficients | |
|---|---|
| K | 0.000000 |

| | | | |
|---|---|---|---|
| A | −0.210877 E−05 | B | 0.446056 E−09 |
| C | −0.108234 E−11 | D | −0.947112 E−15 |

| | |
|---|---|
| d4 | 9.363008 |

| | |
|---|---|
| s5* | r5 |
| | −143.19062 |
| | Aspherical Surface Coefficients |

| | |
|---|---|
| K | 0.000000 |

| | | | |
|---|---|---|---|
| A | 0.915202 E−07 | B | 0.583182 E−09 |
| C | −0.150966 E−11 | D | −0.674630 E−16 |

TABLE 31
Example 3

| | |
|---|---|
| d5 | 21.132666 |

| | | | | | |
|---|---|---|---|---|---|
| JL | L2 | N3 | ν3 | s6 | r6 |
| | | 1.84762 | 26.973 | | −1182.62752 |

| | |
|---|---|
| d6 | 1.014957 |

| | | | s7 | r7 |
|---|---|---|---|---|
| L3 | N4 | ν4 | | 18.37525 |

| | | | |
|---|---|---|---|
| 1.54756 | 63.264 | d7 | 14.570070 |

| | | | s8 | r8 |
|---|---|---|---|---|
| L4 | N5 | ν5 | | −22.66180 |

| | | | |
|---|---|---|---|
| 1.81563 | 25.455 | d8 | 1.000000 |

| | |
|---|---|
| s9 | r9 |
| | 70.98212 |

TABLE 32
Example 3

| | |
|---|---|
| d9 | 0.600000 |

| | | | | |
|---|---|---|---|---|
| L5 | N6 | ν6 | s10* | r10 |
| | 1.71263 | 53.096 | | 96.75012 |
| | | | | Aspherical Surface Coefficients |

| | |
|---|---|
| K | 0.000000 |

| | | | |
|---|---|---|---|
| A | −0.274014 E−07 | B | 0.718682 E−08 |
| C | −0.920978 E−11 | D | 0.342208 E−13 |

| | |
|---|---|
| d10 | 5.986397 |

| | |
|---|---|
| s11* | r11 |
| | −64.24822 |
| | Aspherical Surface Coefficients |

| | |
|---|---|
| K | 0.000000 |

| | | | |
|---|---|---|---|
| A | −0.420898 E−05 | B | −0.119982 E−08 |
| C | −0.100328 E−10 | D | 0.106825 E−13 |

TABLE 33
Example 3

| | |
|---|---|
| d11 | 21.270512 |

| L6 | N7 | ν7 | s12 | r12 |
|---|---|---|---|---|
| | 1.79842 | 22.603 | | −427.29720 |

| | |
|---|---|
| d12 | 4.137121 |

| | |
|---|---|
| s13 | r13 |
| | −60.56319 |

TABLE 34
Example 3

| | |
|---|---|
| d13 | 0.100000 |

| | | |
|---|---|---|
| ST | s14 | r14 |
| | | ∞ |

TABLE 35
Example 3

| | |
|---|---|
| d14 | 170.400211 |

| | | | | |
|---|---|---|---|---|
| L7 | N8 | ν8 | s15 | r15 |
| | 1.75703 | 50.478 | | 91.82393 |

| | |
|---|---|
| d15 | 14.833998 |

| | |
|---|---|
| s16 | r16 |
| | −667.83952 |

TABLE 36
Example 3

| | |
|---|---|
| d16 | 40.016363 |

| | | | | |
|---|---|---|---|---|
| L8 | N9 | ν9 | s17* | r17 |
| | 1.74485 | 51.899 | | −47.55941 |
| | | | | Aspherical Surface Coefficients |

| | |
|---|---|
| K | 0.000000 |

| | | | |
|---|---|---|---|
| A | 0.338811 E−05 | B | −0.210526 E−08 |
| C | 0.160749 E−11 | D | −0.310395 E−15 |

| | |
|---|---|
| d17 | 1.000000 |

| | |
|---|---|
| s18* | r18 |
| | 243.40007 |
| | Aspherical Surface Coefficients |

| | |
|---|---|
| K | 0.000000 |

| | | | |
|---|---|---|---|
| A | 0.177293 E−05 | B | −0.174175 E−08 |
| C | 0.966226 E−12 | D | −0.194031 E−15 |

TABLE 37
Example 3

| | |
|---|---|
| d18 | 100.000000 |

| | | | | |
|---|---|---|---|---|
| L9 | N10 | ν10 | s19$ | r19 |
| | 1.49270 | 57.491 | | ∞ |

| Free-form Surface Coefficients | | | | | |
|---|---|---|---|---|---|
| C(2, 1) | 2.5247 E−05 | C(0, 3) | 5.2156 E−05 | C(4, 0) | −5.7272 E−07 |
| C(2, 2) | −1.9249 E−07 | C(0, 4) | −3.1708 E−06 | C(4, 1) | −1.6227 E−08 |
| C(2, 3) | −6.6915 E−08 | C(0, 5) | 5.0532 E−08 | C(6, 0) | −1.0357 E−11 |
| C(4, 2) | 1.4101 E−09 | C(2, 4) | 1.6855 E−09 | C(0, 6) | −6.6088 E−13 |
| C(6, 1) | −2.3410 E−12 | C(4, 3) | −1.9544 E−11 | C(2, 5) | −9.3395 E−12 |
| C(0, 7) | −7.0329 E−12 | C(8, 0) | 7.9198 E−14 | C(6, 2) | −2.9749 E−14 |
| C(4, 4) | 7.9184 E−14 | C(2, 6) | −3.5322 E−14 | C(0, 8) | 4.9116 E−14 |

| | |
|---|---|
| d19 | 5.000000 |

| | |
|---|---|
| s20 | r20 |
| | ∞ |

TABLE 38
Example 3

| | | |
|---|---|---|
| MC1 | s21$ | r21 |
| | | ∞ |
| | | Decentering Displacements |

| XDE | 0.000000 | YDE | 8.000000 | ZDE | 519.945304 |
|---|---|---|---|---|---|
| ADE | −37.218162 | BDE | 0.000000 | CDE | 0.000000 |
| Free-form Surface Coefficients | | | | | |
| C(0, 1) | −1.9959 E−01 | C(2, 0) | −2.1642 E−03 | C(0, 2) | −2.3032 E−03 |
| C(2, 1) | 1.6820 E−05 | C(0, 3) | 8.5824 E−05 | C(4, 0) | 8.5898 E−08 |
| C(2, 2) | 7.7768 E−07 | C(0, 4) | −2.4157 E−06 | C(4, 1) | −2.8954 E−09 |
| C(2, 3) | −2.0308 E−08 | C(0, 5) | 4.1394 E−08 | C(6, 0) | 1.3548 E−12 |
| C(4, 2) | −4.4938 E−11 | C(2, 4) | 1.4211 E−10 | C(0, 6) | −3.8207 E−10 |
| C(6, 1) | 4.4149 E−14 | C(4, 3) | −5.9851 E−16 | C(2, 5) | 2.0286 E−13 |
| C(0, 7) | 1.3768 E−12 | C(8, 0) | −7.3296 E−15 | C(6, 2) | 2.4415 E−14 |
| C(4, 4) | 4.9204 E−14 | C(2, 6) | −2.9528 E−15 | C(0, 8) | 4.9152 E−15 |
| C(8, 1) | −1.0890 E−16 | C(6, 3) | −4.8636 E−16 | C(4, 5) | −6.7610 E−16 |
| C(2, 7) | −2.1116 E−17 | C(0, 9) | −5.9388 E−17 | C(10, 0) | 2.6710 E−18 |
| C(8, 2) | 4.2080 E−19 | C(6, 4) | 2.3086 E−18 | C(4, 6) | 2.5801 E−18 |
| C(2, 8) | 1.0350 E−19 | C(0, 10) | 1.5112 E−19 | | |

TABLE 39
Example 3

| | | |
|---|---|---|
| MC2 | s22$ | r22 |
| | | ∞ |
| | | Decentering Displacements |

| XDE | 0.000000 | YDE | 62.038925 | ZDE | 477.634160 |
|---|---|---|---|---|---|
| ADE | −8.722480 | BDE | 0.000000 | CDE | 0.000000 |
| Free-form Surface Coefficients | | | | | |
| C(0, 1) | 2.7118 E−01 | C(2, 0) | −1.3875 E−02 | C(0, 2) | −2.6105 E−03 |
| C(2, 1) | 3.1188 E−04 | C(0, 3) | 2.1898 E−05 | C(4, 0) | −2.7784 E−07 |
| C(2, 2) | −3.3003 E−06 | C(0, 4) | −2.0405 E−08 | C(4, 1) | −7.0394 E−09 |
| C(2, 3) | 7.9471 E−09 | C(0, 5) | −6.6701 E−10 | C(6, 0) | 6.6114 E−11 |
| C(4, 2) | 1.8677 E−10 | C(2, 4) | 1.2507 E−10 | C(0, 6) | 2.6023 E−12 |
| C(6, 1) | 1.3101 E−12 | C(4, 3) | −1.6026 E−15 | C(2, 5) | −8.1325 E−13 |
| C(0, 7) | 9.1589 E−15 | C(8, 0) | −2.1345 E−14 | C(6, 2) | −7.1862 E−14 |
| C(4, 4) | −1.6176 E−14 | C(2, 6) | −1.7820 E−15 | C(0, 8) | −5.0855 E−17 |
| C(8, 1) | 6.8771 E−16 | C(6, 3) | 6.1610 E−16 | C(4, 5) | 9.5532 E−17 |
| C(2, 7) | 2.9085 E−17 | C(0, 9) | −1.3558 E−19 | C(10, 0) | −2.1763 E−18 |
| C(8, 2) | −3.2274 E−18 | C(6, 4) | −1.4815 E−18 | C(4, 6) | −1.6169 E−19 |
| C(2, 8) | −7.2995 E−20 | C(0, 10) | 6.9666 E−22 | | |

TABLE 40
Example 3

| | | | | |
|---|---|---|---|---|
| L10 | N11 | ν11 | s23 | r23 |
| | 1.42970 | 57.491 | | ∞ |
| | | | | Decentering Displacements |

| | | | | | |
|---|---|---|---|---|---|
| XDE | 0.000000 | YDE | 108.547767 | ZDE | 573.073572 |
| ADE | 15.040920 | BDE | 0.000000 | CDE | 0.000000 |

| | |
|---|---|
| d20 | 10.000000 |

| | |
|---|---|
| s24$ | r24 |
| | ∞ |
| | Free-form Surface Coefficients |

| | | | | | |
|---|---|---|---|---|---|
| C(2, 1) | 4.6356 E−07 | C(0, 3) | −2.9320 E−05 | C(4, 0) | −8.9250 E−09 |
| C(2, 2) | 2.6858 E−07 | C(0, 4) | 9.1762 E−07 | C(4, 1) | −1.1122 E−09 |
| C(2, 3) | −6.9672 E−09 | C(0, 5) | −1.6056 E−08 | C(6, 0) | 1.0409 E−12 |
| C(4, 2) | 1.0939 E−12 | C(2, 4) | 5.5177 E−11 | C(0, 6) | 1.5654 E−10 |
| C(6, 1) | 6.4506 E−14 | C(4, 3) | 3.0233 E−13 | C(2, 5) | −1.1147 E−13 |
| C(0, 7) | −7.7542 E−13 | C(8, 0) | −5.6686 E−17 | C(6, 2) | −8.7574 E−16 |
| C(4, 4) | −1.8909 E−15 | C(2, 6) | −1.5393 E−16 | C(0, 8) | 1.4579 E−15 |

TABLE 41
Example 3

| | | |
|---|---|---|
| MH | s25 | r25 |
| | | ∞ |
| | | Decentering Displacements |

| | | | | | |
|---|---|---|---|---|---|
| XDE | 0.000000 | YDE | 243.405277 | ZDE | 1074.934695 |
| ADE | 33.858484 | BDE | 0.000000 | CDE | 0.000000 |

TABLE 42
Example 3

| | | |
|---|---|---|
| SC | s26 | r26 |
| | | ∞ |
| | | Decentering Displacements |

| | | | | | |
|---|---|---|---|---|---|
| XDE | 0.000000 | YDE | 239.251375 | ZDE | 1077.601212 |
| ADE | 115.519422 | BDE | 0.000000 | CDE | 0.000000 |

TABLE 43

| | | Example 1 | Example 2 | Example 3 |
|---|---|---|---|---|
| Conditional Formula(1) | θα | 70.57 | 70.99 | 70.29 |
| Conditional Formula(2) | θ1 | 34.1 | 34.5 | 35.3 |
| Conditional Formula(3) | θ2 | 39.0 | 40.1 | 41.1 |
| Conditional Formula(4) | θ3 | 9.8 | 11.1 | 11.7 |
| Conditional Formula(5) | H × | −2.33928 | −2.26484 | −2.31161 |
| | r(MC1) | | | |
| Conditional Formula(6) | H × | 7.94061 | 9.32355 | 9.36424 |
| | r(MC2) | | | |

What is claimed is:

1. An image projection apparatus comprising a projection optical system unit which performs projection on a projection surface by guiding image light emitted from a light modulation element, the projection optical system unit including: a refractive optical system having an optical aperture stop; a curved mirror optical system having at least a first curved mirror and a second curved mirror which reflects light reflected via the first curved mirror; and an optical path change mirror optical system which changes a traveling direction of image light at least once,
wherein, provided that image light traveling from a center of a display surface of the light modulation element toward a center of the projection surface is a base ray, an angle θα [°] of incidence of the base ray with respect to the projection surface satisfies conditional formula (1) below:
55<θα<76 Conditional formula (1), and
wherein the first curved mirror and the second curved mirror are located so that an optical path of the base ray reaching the first curved mirror and an optical path of the base ray leaving the second curved mirror intersect with each other, and
wherein the first curved mirror is located between the second curved mirror and the projection surface.

2. The image projection apparatus according to claim 1,
wherein conditional formula (2) below is satisfied;
25<θ1<45 Conditional formula (2),
where
θ1: represents an angle [unit; °] of incidence of the base ray with respect to the first curved mirror.

3. The image projection apparatus according to claim 2,
wherein conditional formula (2a) below is satisfied:
30<θ1<40 Conditional formula (2a).

4. The image projection apparatus according to claim 1,
wherein conditional formula (3) below is satisfied:
30<θ2<50 Conditional formula (3),
where
θ2: represents an angle [unit; °] of incidence of the base ray with respect to the second curved mirror.

5. The image projection apparatus according to claim 4,
wherein conditional formula (3a) below is satisfied:
35<θ2<45 Conditional formula (3a).

6. The image projection apparatus according to claim 4,
wherein conditional formula (2) below is satisfied:
25<θ1<45 Conditional formula (2),
where
θ1: represents an angle [unit; °] of incidence of the base ray on the first curved mirror.

7. The image projection apparatus according to claim 1,
wherein conditional formula (4) below is satisfied:
0<θ3<20 Conditional formula (4),
where
θ3: represents the angle [unit; °] formed by a direction of the base ray reaching the first curved mirror and a direction of the base ray leaving the second curved mirror.

8. The image projection apparatus according to claim 7,
wherein conditional formula (2) below is satisfied:
25<θ1<45 Conditional formula (2),
where
θ1: represents an angle [unit; °] of incidence of the base ray with respect to the first curved mirror.

9. The image projection apparatus according to claim 7,
wherein conditional formula (3) below is satisfied:
30<θ2<50 Conditional formula (3),
where
θ2: represents an angle [unit; °] of incidence of the base ray with respect to the second curved mirror.

10. The image projection apparatus according to claim 9,
wherein conditional formula (2) below is satisfied:
25<θ1<45 Conditional formula (2),
where
θ1: represents an angle [unit; °] of incidence of the base ray on the first curved mirror.

11. The image projection apparatus according to claim 1,
wherein conditional formula (5) below is satisfied
−3.3<H×r(MC1)<−1.0 Conditional formula (5),
where
H: represents a length [unit; mm] in one direction (horizontal direction) of a local coordinate system defined on the projection surface; and
r(MC1): represents curvature [unit; 1/mm], at a point of a reflection surface of the first curved mirror where the base ray reaches, in a same direction as the horizontal direction possessed by the reflection surface (if the reflection surface is concave, a sign of a curvature value is “negative”).

12. The image projection apparatus according to claim 11,
wherein conditional formula (2) below is satisfied:
25<θ1<45 Conditional formula (2),
where
θ1: represents an angle [unit; °] of incidence of the base ray with respect to the first curved mirror.

13. The image projection apparatus according to claim 11,
wherein conditional formula (3) below is satisfied:
30<θ2<50 Conditional formula (3),
where
θ2: represents an angle [unit; 0] of incidence of the base ray with respect to the second curved mirror.

14. The image projection apparatus according to claim 13,
wherein conditional formula (2) below is satisfied:
25<θ1<45 Conditional formula (2),
where
θ1: represents an angle [unit; °] of incidence of the base ray with respect to the first curved mirror.

15. The image projection apparatus according to claim 1,
wherein conditional formula (6) below is satisfied:
6.0<H×r(MC2)<11.0 Conditional formula (6),
where
H: represents a length [unit; mm] in one direction (horizontal direction) of a rectangular coordinate system defined on the projection surface; and
r(MC2): represents curvature [unit; 1/mm], at a point of a reflection surface of the second curved mirror where the base ray reaches, in a same direction as the horizontal direction possessed by the reflection surface (if the reflection surface is convex, a sign of a curvature value is “positive”).

16. The image projection apparatus according to claim 15,
wherein conditional formula (2) below is satisfied:
25<θ1<45 Conditional formula (2),
where
θ1: represents an angle [unit; °] of incidence of the base ray with respect to the first curved mirror.

17. The image projection apparatus according to claim 15,
wherein conditional formula (3) below is satisfied:
30<θ2<50 Conditional formula (3),
where
θ2: represents an angle [unit; °] of incidence of the base ray with respect to the second curved mirror.

18. The image projection apparatus according to claim 17,
wherein conditional formula (2) below is satisfied:
25<θ1<45 Conditional formula (2),
where
θ1: represents an angle [unit; °] of incidence of the base ray with respect to the first curved mirror.

19. The image projection apparatus according to claim 1,
wherein the optical path change element which changes the optical path of the image light is provided on an optical path in the refractive optical system or on an optical path extending from the refractive optical system to the curved mirror optical system.

20. The image projection apparatus according to claim 1, comprising a light modulation element which emits image light.
